(19) United States
(12) Patent Application Publication
(10) Pub. No.: US 2026/0172349 A1
(43) Pub. Date: Jun. 18, 2026

(54) MULTI VR FORWARDING IN PANOS SDWAN DEPLOYMENT

(71) Applicant: Palo Alto Networks, Inc., Santa Clara, CA (US)

(72) Inventors: Apoorv Bhargava, Hayward, CA (US); Jason Baucom, Elk Grove, CA (US); Sameer Kumar, Fremont, CA (US)

(21) Appl. No.: 19/255,557

(22) Filed: Jun. 30, 2025

Related U.S. Application Data
(63) Continuation-in-part of application No. 18/982,950, filed on Dec. 16, 2024.

(51) Int. Cl. H04L 45/586; H04L 9/40; H04L 12/46; H04L 45/02

(52) U.S. Cl. CPC H04L 45/586; H04L 12/4633; H04L 45/04; H04L 63/02; H04L 2212/00

(57) ABSTRACT

The present application discloses a method, system, and computer system for managing traffic in a Software-Defined Wide Area Network (SD-WAN) comprising a hub and multiple spoke, each spoke having one or more Virtual Routers (VRs). The method includes: (a) receiving, at the hub, encapsulated traffic from a spoke over a tunnel, wherein the encapsulated traffic includes a global virtual router identifier (VR_ID) corresponding to a VR on the spoke, (b) determining, based on the global VR_ID, a zone associated with the VR, and (c) forwarding return traffic to the spoke by encapsulating the return traffic with the global VR_ID corresponding to the VR on the spoke.

### CROSS REFERENCE TO OTHER APPLICATIONS

This application is a continuation in part of pending U.S. patent application Ser. No. 18/982,950 entitled INTER VIRTUAL ROUTER FORWARDING WITH FIREWALL INTELLIGENCE filed Dec. 16, 2024, which is incorporated herein by reference for all purposes.

### BACKGROUND OF THE INVENTION

In modern network environments, there is an increasing demand for flexible, scalable, and secure traffic management, particularly in software-defined wide area network (SD-WAN) deployments. Enterprises frequently implement network segmentation using virtual routing and forwarding (VRF) instances, which enable the use of the same IP address space across different client segments. This segmentation is particularly useful in managed network environments, where clients may require unique security policies, network controls, and segregated data flows.

### BRIEF DESCRIPTION OF THE DRAWINGS

Various embodiments of the invention are disclosed in the following detailed description and the accompanying drawings.

FIG. 1 is a block diagram of an environment for performing inter-virtual router forwarding according to various embodiments.

FIG. 2 is a block diagram of an environment for performing inter-virtual router forwarding according to various embodiments.

FIG. 3 is a block diagram of an environment for performing inter-virtual router forwarding according to various embodiments.

FIG. 4 is a block diagram of an environment for performing inter-virtual router forwarding according to various embodiments.

FIG. 5 is an example of routing information for inter-virtual router forwarding according to various embodiments.

FIG. 6 is a flow diagram of a method for routing traffic according to various embodiments.

FIG. 7 is a flow diagram of a method for routing inbound network traffic from a server in connection with a server-to-client flow according to various embodiments.

FIG. 8 is a flow diagram of a method for routing network traffic received from a client in connection with a client-to-server flow according to various embodiments.

FIG. 9 is a flow diagram of a method for storing virtual router forwarding information in connection with received network traffic according to various embodiments.

FIG. 10 is a flow diagram of a method for routing inbound network traffic from a server in connection with a server-to-client flow according to various embodiments.

FIG. 11 is a flow diagram of a method for handling ingress traffic at a hub using an encapsulated virtual router identifier according to various embodiments.

FIG. 12 is a flow diagram of a method for handling session initialization and return (S2C) path handling.

FIG. 13 is a flow diagram of a method for handling outbound traffic at a branch according to various embodiments.

FIG. 14 is a flow diagram of a method for establishing independent BGP sessions for a virtual router(s) using dummy interfaces according to various embodiments.

FIG. 15 is a flow diagram of a method for orchestrating virtual router identifier consistency across a plurality of hubs and branch devices.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

A common challenge arises when clients segmented using virtual routing and forwarding access shared resources, such as the internet, through a common network security device like a Next-Generation Firewall (NGFW). Managing overlapping IP addresses while maintaining unique session tracking, security policy enforcement, and traffic routing per client segment is a complex task. Existing solutions often require separate, costly physical or logical resources to manage each segment, which is not always practical or efficient for scalable deployments.

Various embodiments provide a method, system, and computer system for routing network traffic to be sent through a firewall, the network traffic being routed to the appropriate client when the firewall services clients having overlapping IP addresses. The method includes: (a) storing an ingress virtual routing and forwarding (VRF) information in connection with a client-server flow information for a particular session, and (b) causing network traffic received from a server to be routed based at least in part on the VRF information.

Various embodiments provide a method, system, and computer system for managing traffic in a Software-Defined Wide Area Network (SD-WAN) comprising a hub and multiple spoke, each spoke having one or more Virtual Routers (VRs). The method includes: (a) receiving, at the hub, encapsulated traffic from a spoke over a tunnel, wherein the encapsulated traffic includes a global virtual router identifier (VR_ID) corresponding to a VR on the spoke, (b) determining, based on the global VR_ID, a zone associated with the VR, and (c) forwarding return traffic to the spoke by encapsulating the return traffic with the global VR_ID corresponding to the VR on the spoke.

In conventional network security and routing systems, VRF instances are commonly used to achieve logical network segregation, enabling clients to have isolated access to resources while sharing underlying physical infrastructure. This approach is especially valuable in enterprise environments, data centers, and managed networks, where multiple clients or tenants may require distinct routing domains for privacy, security, or policy-based management. Typically, inter-virtual router forwarding (inter VRF) involves configuring route-leak to allow traffic between the virtual routers. If multiple VRF clients with same IPs want to access an Internet VRF, related art systems are unable to support this through standard routing.

In traditional systems, VRFs supported by network security devices, such as firewalls, are typically configured to prevent overlapping IP address spaces among different VRFs. This restriction exists because most conventional firewalls identify and manage traffic flows based on IP addresses, which are assumed to be unique across the system. When multiple clients require the same IP address ranges (e.g., 10.0.0.0/24) within different VRFs, the firewall cannot reliably distinguish between these clients, as there is no mechanism to isolate traffic uniquely based on the VRF context.

This limitation in conventional systems forces network administrators to either assign globally unique IP address spaces to each VRF, which can be impractical or costly in large-scale deployments, or deploy separate physical or virtual firewalls for each VRF, significantly increasing infrastructure and management costs. As a result, existing solutions lack flexibility and scalability, particularly for managed SD-WAN environments where clients or tenants may require both isolated address spaces and shared internet access through a unified firewall.

The need for flexible network design is particularly pronounced in SD-WAN deployments, where organizations want to maintain efficient, secure internet access for clients while enforcing both network and security segregation. Without the ability to handle overlapping IP address spaces across VRFs, administrators face a significant challenge in meeting these requirements, especially when multiple tenants or clients need consistent address configurations that may not be globally unique.

Therefore, there is a need for an improved system that supports overlapping IP address spaces among VRFs in a way that enables secure, scalable, and efficient traffic management within shared network security devices like next-generation firewalls (NGFWs). Such a system would allow VRFs to coexist with overlapping address spaces while maintaining the firewall's ability to enforce security policies and track sessions independently for each client.

According to various embodiments the system stores the ingress VRF in association with the client-to-server (C2S) flow, and when server sends the return traffic (e.g., when the system receives the return traffic from the server), the system bypasses the route lookup in the internet VRF based on the implementation of the route lookup in the ingress VRF information obtained from session lookup. In some embodiments, the system implements unique routing information for C2S traffic and/or S2C traffic. The system can store unique routing information for C2S traffic based at least in part on ensuring flows in a given virtual-router (VR) has a corresponding and/or unique zone. For example, each VR is assigned a unique virtual router identifier, and the system stores a mapping between session identifiers and corresponding virtual router identifiers (e.g., for the VRs through which clients are accessing the network to obtain service from the server) for each particular session. The system can store unique routing information S2C traffic unique based at least in part on implementing source network address translation (SRC NAT) when traffic is egressed over the internet. The system can implement these techniques in connection with an SDWAN hub multi-VR and SDWAN branch muti-VR. In some embodiments, the system implements dummy logical interfaces (e.g., SDWAN bundles in one VR) wrapping an underlying SDWAN bundle which belongs to another VR, thereby supporting inter-VR forwarding.

Various embodiments implement book-keeping performed at the firewall (e.g., a next generation firewall) to maintain C2S and S2C flows. The system can support overlapping IP address spaces across VRs by extending the book-keeping maintained at the firewall to include storing routing information based on existing firewall constructs like zones (e.g., virtual router ingress interface identifiers, virtual router ingress interface identifiers, etc.) and network address translation (NAT).

Various embodiments provide a method for implementing Inter VRF and/or a network security system that comprises a plurality of VRFs that enable overlapping IP address spaces across different clients (e.g., two clients from accessing the network via different VRs can have the same IP address). The system, which may be implemented within a NGFW or similar device, supports network traffic segregation and enforces security policies for each VRF while managing C2S and S2C flows uniquely and securely.

According to various embodiments, for C2S flows, the system identifies each flow based on an identifier associated with the VRF (e.g., a unique zone identifier associated with the ingress interface for the VRF) from which the traffic is received. This VRF identifier (or zone identifier) is stored in the session information, ensuring each client flow can be managed independently, even when IP addresses overlap among clients.

According to various embodiments, for S2C flows, the system utilizes source network address translation (NAT) upon egressing traffic over the internet. It performs a lookup to determine an address and port associated with the VRF corresponding to the C2S flow. This enables accurate routing of S2C flows back to the correct VRF and client, ensuring proper session continuity and secure data flow management.

In SD-WAN scenarios, various embodiments enable network operators to implement both network and security segregation effectively. Network operators can place clients in separate VRFs, thereby reusing IP address spaces, while providing them internet access through a unified NGFW. Additionally, security segregation is enhanced by assigning distinct security zones to VRFs, which allows differentiated security policies and controls per client segment.

This system is particularly suitable for SD-WAN deployments where multiple clients, potentially with overlapping IP address requirements, access the internet through a shared NGFW. It enables pure network segregation while maintaining unified internet access, providing significant cost and efficiency benefits over traditional network architecture.

### Advanced or Next Generation Firewalls

Malware is a general term commonly used to refer to malicious software (e.g., including a variety of hostile, intrusive, and/or otherwise unwanted software). Malware can be in the form of code, scripts, active content, and/or other software. Example uses of malware include disrupting computer and/or network operations, stealing proprietary information (e.g., confidential information, such as identity, financial, and/or intellectual property related information), and/or gaining access to private/proprietary computer systems and/or computer networks. Unfortunately, as techniques are developed to help detect and mitigate malware, nefarious authors find ways to circumvent such efforts. Accordingly, there is an ongoing need for improvements to techniques for identifying and mitigating malware.

A firewall generally protects networks from unauthorized access while permitting authorized communications to pass through the firewall. A firewall is typically a device, a set of devices, or software executed on a device that provides a firewall function for network access. For example, a firewall can be integrated into operating systems of devices (e.g., computers, smart phones, or other types of network communication capable devices). A firewall can also be integrated into or executed as software applications on various types of devices or security devices, such as computer servers, gateways, network/routing devices (e.g., network routers), or data appliances (e.g., security appliances or other types of special purpose devices, and in some implementations, certain operations can be implemented in special purpose hardware, such as an ASIC or FPGA).

Firewalls typically deny or permit network transmission based on a set of rules. These sets of rules are often referred to as policies (e.g., network policies or network security policies). For example, a firewall can filter inbound traffic by applying a set of rules or policies to prevent unwanted outside traffic from reaching protected devices. A firewall can also filter outbound traffic by applying a set of rules or policies (e.g., allow, block, monitor, notify or log, and/or other actions can be specified in firewall rules or firewall policies, which can be triggered based on various criteria, such as described herein). A firewall can also filter local network (e.g., intranet) traffic by similarly applying a set of rules or policies.

Security devices (e.g., security appliances, security gateways, security services, and/or other security devices) can perform various security operations (e.g., firewall, anti-malware, intrusion prevention/detection, proxy, and/or other security functions), networking functions (e.g., routing, Quality of Service (QoS), workload balancing of network related resources, and/or other networking functions), and/or other security and/or networking related operations. For example, routing can be performed based on source information (e.g., IP address and port), destination information (e.g., IP address and port), and protocol information (e.g., layer-3 IP-based routing).

A basic packet filtering firewall filters network communication traffic by inspecting individual packets transmitted over a network (e.g., packet filtering firewalls or first generation firewalls, which are stateless packet filtering firewalls). Stateless packet filtering firewalls typically inspect the individual packets themselves and apply rules based on the inspected packets (e.g., using a combination of a packet's source and destination address information, protocol information, and a port number).

Application firewalls can also perform application layer filtering (e.g., using application layer filtering firewalls or second generation firewalls, which work on the application level of the TCP/IP stack). Application layer filtering firewalls or application firewalls can generally identify certain applications and protocols (e.g., web browsing using HyperText Transfer Protocol (HTTP), a Domain Name System (DNS) request, a file transfer using File Transfer Protocol (FTP), and various other types of applications and other protocols, such as Telnet, DHCP, TCP, UDP, and TFTP (GSS)). For example, application firewalls can block unauthorized protocols that attempt to communicate over a standard port (e.g., an unauthorized/out of policy protocol attempting to sneak through by using a non-standard port for that protocol can generally be identified using application firewalls).

Stateful firewalls can also perform stateful-based packet inspection in which each packet is examined within the context of a series of packets associated with that network transmission's flow of packets/packet flow (e.g., stateful firewalls or third generation firewalls). This firewall technique is generally referred to as a stateful packet inspection as it maintains records of all connections passing through the firewall and is able to determine whether a packet is the start of a new connection, a part of an existing connection, or is an invalid packet. For example, the state of a connection can itself be one of the criteria that triggers a rule within a policy.

Advanced or next generation firewalls can perform stateless and stateful packet filtering and application layer filtering as discussed above. Next generation firewalls can also perform additional firewall techniques. For example, certain newer firewalls sometimes referred to as advanced or next generation firewalls can also identify users and content. In particular, certain next generation firewalls are expanding the list of applications that these firewalls can automatically identify to thousands of applications. Examples of such next generation firewalls are commercially available from Palo Alto Networks, Inc. (e.g., Palo Alto Networks'PA Series firewalls).

For example, Palo Alto Networks'next generation firewalls enable enterprises to identify and control applications, users, and content-not just ports, IP addresses, and packets-using various identification technologies, such as the following: App-ID for accurate application identification, User-ID for user identification (e.g., by user or user group), and Content-ID for real-time content scanning (e.g., controls web surfing and limits data and file transfers). These identification technologies allow enterprises to securely enable application usage using business-relevant concepts, instead of following the traditional approach offered by traditional port-blocking firewalls. Also, special purpose hardware for next generation firewalls implemented, for example, as dedicated appliances generally provides higher performance levels for application inspection than software executed on general purpose hardware (e.g., such as security appliances provided by Palo Alto Networks, Inc., which utilize dedicated, function specific processing that is tightly integrated with a single-pass software engine to maximize network throughput while minimizing latency).

Advanced or next generation firewalls can also be implemented using virtualized firewalls. Examples of such next generation firewalls are commercially available from Palo Alto Networks, Inc. (e.g., Palo Alto Networks'firewalls, which support various commercial virtualized environments, including, for example, VMware® ESXi™ and NSX™, Citrix® Netscaler SDX™, KVM/OpenStack (Centos/RHEL, Ubuntu®), and Amazon Web Services (AWS)). For example, virtualized firewalls can support similar or the exact same next-generation firewall and advanced threat prevention features available in physical form factor appliances, allowing enterprises to safely enable applications flowing into, and across their private, public, and hybrid cloud computing environments. Automation features such as VM monitoring, dynamic address groups, and a REST-based API allow enterprises to proactively monitor VM changes dynamically feeding that context into security policies, thereby eliminating the policy lag that may occur when VMs change.

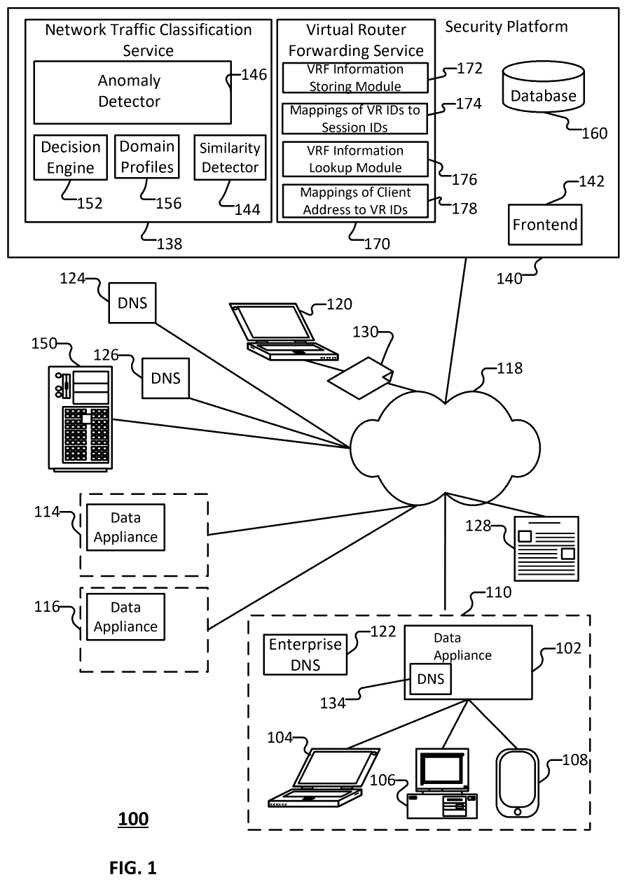

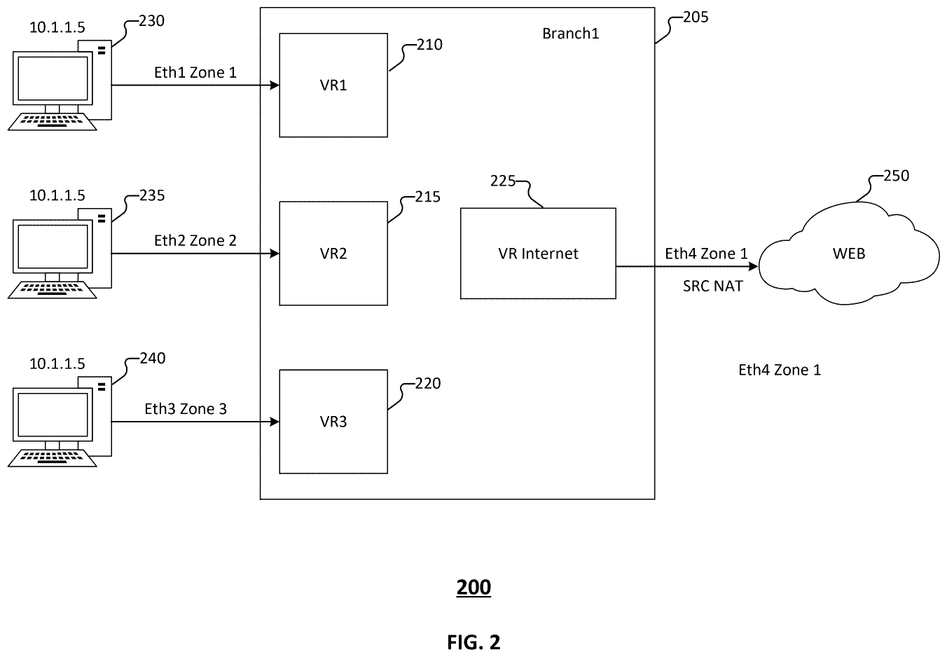

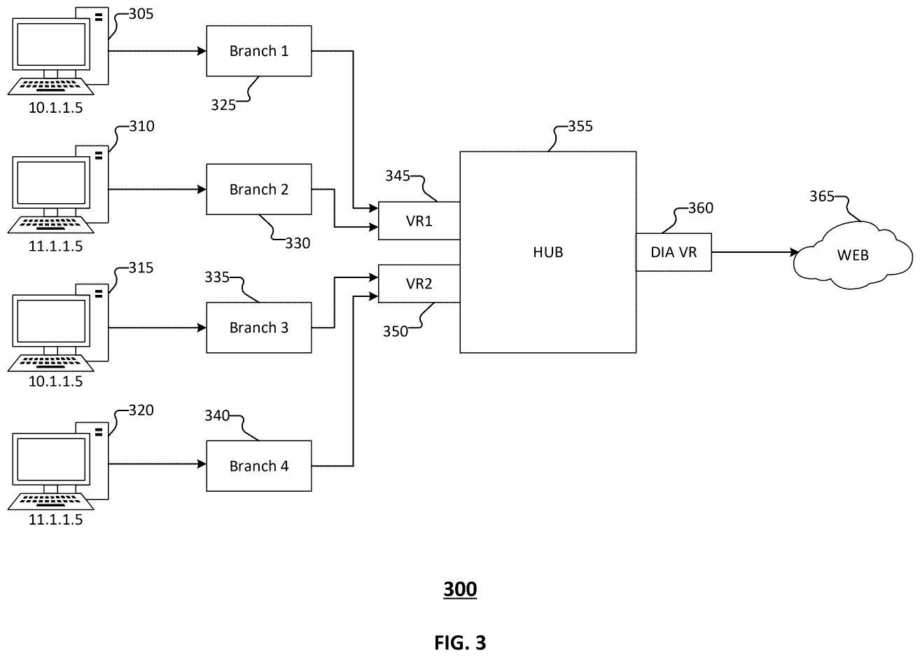

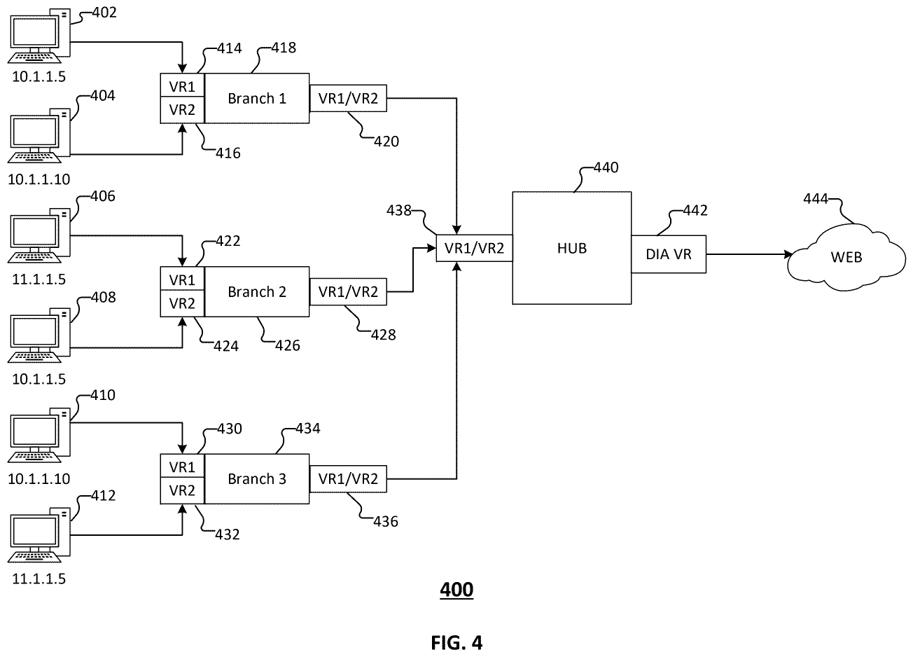

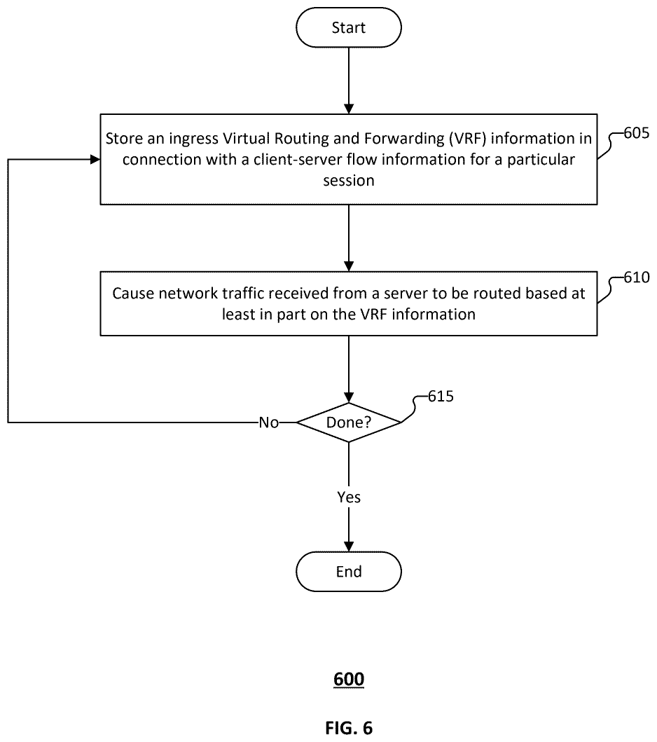

FIG. 1 is a block diagram of an environment for performing inter-virtual router forwarding according to various embodiments. In some embodiments, system 100 implements at least part of one or more of system 200 of FIG. 2, system 300 of FIG. 3, and/or system 400 of FIG. 4. System 100 can implement one or more of processes processes 600-1500 of FIGS. 6-1500.

In the example shown, client devices 104-108 are a laptop computer, a desktop computer, and a tablet (respectively) present in an enterprise network 110 (belonging to the “Acme Company”). Data appliance 102 is configured to enforce policies (e.g., a security policy, a network traffic handling policy, etc.) regarding communications between client devices, such as client devices 104 and 106, and nodes outside of enterprise network 110 (e.g., reachable via external network 118). Examples of such policies include policies governing traffic shaping, quality of service, and routing of traffic. Other examples of policies include security policies such as ones requiring the scanning for threats in incoming (and/or outgoing) email attachments, website content, inputs to application portals (e.g., web interfaces), files exchanged through instant messaging programs, and/or other file transfers. Other examples of policies include security policies (or other traffic monitoring policies) that selectively block traffic, such as traffic to malicious domains, DNS hijacked domains, or stockpiled domains, or such as traffic for certain applications (e.g., SaaS applications). In some embodiments, data appliance 102 is also configured to enforce policies with respect to traffic that stays within (or from coming into) enterprise network 110. In some embodiments, data appliance 102 is a network edge device. For example, data appliance 102 can implement ION device functionality, security services (e.g., firewall functionality), etc.

Techniques described herein can be used in conjunction with a variety of platforms (e.g., desktops, mobile devices, gaming platforms, embedded systems, etc.) and/or a variety of types of applications (e.g., Android . ask files, iOS applications, Windows PE files, Adobe Acrobat PDF files, Microsoft Windows PE installers, etc.). In the example environment shown in FIG. 1, client devices 104-108 are endpoints, such as a laptop computer, a desktop computer, and a tablet (respectively) present in an enterprise network 110. Client device 120 is a laptop computer present outside of enterprise network 110.

Data appliance 102 can be configured to work in cooperation with remote security platform 140. Security platform 140 can provide a variety of services, including classifying domains (e.g., predicting whether a domain is a malicious domain, etc.), classifying DNS response records (e.g., predicting whether a domain IP pair in a DNS response is a DNS hijacked record, etc.), classifying network traffic, providing a mapping of signatures to certain domains or DNS records (e.g., a DNS record for which a predicted likelihood that the record is a DNS hijacked record exceeds a predefined likelihood threshold, etc. a mapping of domains or DNS records to domain or DNS record data (e.g., domain certificates, pen's data, active DNS data, WHOIS data, etc.), performing static and dynamic analysis on malware samples, monitoring new domains and new DNS records (e.g., detecting new domains for which a certificate is issued/generated), assessing maliciousness of domains, determining whether a DNS record associated with a traffic sample is (or is likely to be) a DNS hijacked record, providing a list of signatures of known exploits (e.g., malicious input strings, malicious files, malicious domains, etc.) to data appliances, such as data appliance 102 as part of a subscription, detecting exploits such as malicious input strings, malicious files, DNS hijacked records or malicious domains (e.g., an on-demand detection, or periodical-based updates to a mapping of domains or DNS records to indications of whether the domains or DNS records are malicious or benign), providing a likelihood that a domain is malicious (e.g., a DNS hijacked record) or benign (e.g., not DNS hijacked), providing/updating a whitelist of input strings, files, or domains deemed to be benign, providing/updating input strings, files, or domains deemed to be malicious, identifying malicious input strings, detecting malicious input strings, detecting malicious files, predicting whether input strings, files, DNS records, or domains are malicious, providing an indication that an input string, file, DNS record, or domain is malicious (or benign), receive risk signals (e.g., a signal pertaining to an endpoint risk for a network) from one or more other services or products, aggregate a set of risk signals (e.g., to obtain an aggregate risk score or to classify an endpoint), collecting network traffic information (e.g., comprising IP addresses, device information, etc.), determining IP-to-device mappings, filtering the IP-to-device mappings (e.g., for a particular network edge to identify a filtered set of IP-to-device mappings relevant to the particular network edge), distributing to various network edge devices (e.g., data appliance 102) the filtered set of IP-to-device mappings relevant to the various network edge devices, distributing (e.g., to various network edge devices) policies to be enforced at the network edge(s), etc.

In some embodiments, inter VRF is implemented at data appliance 102. For example, data appliance 102 can store the ingress VRF information in connection with a C2S flow information for a particular session. As another example, data appliance 102 causes the network traffic received from a server to be routed based at least in part on the VRF information.

In some embodiments, inter VRF is implemented at security platform 140. For example, security platform 140 can store the ingress VRF information in connection with a C2S flow information for a particular session. As another example, security platform 140 causes the network traffic received from a server to be routed based at least in part on the VRF information. For example, data appliance 102 may be a VR and security platform 140 supports a plurality of VRs, including data appliance 102.

In various embodiments, results of analysis (and additional information pertaining to applications, domains, etc.), such as an analysis or classification performed by security platform 140, are stored in database 160. In various embodiments, security platform 140 comprises one or more dedicated commercially available hardware servers (e.g., having multi-core processor(s), 32 G+ of RAM, gigabit network interface adaptor(s), and hard drive(s)) running typical server-class operating systems (e.g., Linux). Security platform 140 can be implemented across a scalable infrastructure comprising multiple such servers, solid state drives, and/or other applicable high-performance hardware. Security platform 140 can comprise several distributed components, including components provided by one or more third parties. For example, portions or all of security platform 140 can be implemented using the Amazon Elastic Compute Cloud (EC2) and/or Amazon Simple Storage Service (S3). Further, as with data appliance 102, whenever security platform 140 is referred to as performing a task, such as storing data or processing data, it is to be understood that a sub-component or multiple sub-components of security platform 140 (whether individually or in cooperation with third party components) may cooperate to perform that task. As one example, security platform 140 can optionally perform static/dynamic analysis in cooperation with one or more virtual machine (VM) servers. An example of a virtual machine server is a physical machine comprising commercially available server-class hardware (e.g., a multi-core processor, 32+ Gigabytes of RAM, and one or more Gigabit network interface adapters) that runs commercially available virtualization software, such as VMware Six, Citrix eServer, or Microsoft Hyper-V. In some embodiments, the virtual machine server is omitted. Further, a virtual machine server may be under the control of the same entity that administers security platform 140 but may also be provided by a third party. As one example, the virtual machine server can rely on EC2, with the remaining portions of security platform 140 provided by dedicated hardware owned by and under the control of the operator of security platform 140.

According to various embodiments, security platform 140 comprises/implements network traffic classification service 138 and/or virtual router forwarding service 170. Security platform 140 may include various other services/modules, such as a malicious file detector, a malicious traffic detector, a parked domain detector, a DNS hijacked domain or DNS record detector, a DNS traffic classifier, an application classifier or other traffic classifier, etc.

Network traffic classification service 138 is used in connection with analyzing network traffic (e.g., websites, domains, sample files, etc. pertaining to the network traffic) and/or automatically detecting malicious network traffic.

Virtual router forwarding service 170 is used in connection with routing network traffic, such as S2C flows. In some embodiments, virtual router forwarding service 170 supports a plurality of VRs, a plurality of which may have at least partially overlapping IP address spaces. Virtual router forwarding service 170 can properly route network traffic to the appropriate client in systems where a plurality of clients have the same IP address such as in the case when the clients connect to the network via different virtual routers supported by virtual router forwarding service 170.

In some embodiments, virtual router forwarding service 170 comprises one or more of VRF information storing module 172, mappings of VR IDs to session IDs 174, VRF information lookup module 176, and/or mappings of client address to VR IDs 178.

Virtual router forwarding service 170 uses VRF information storing module 172 to store routing information for ingress C2S traffic. In some embodiments, VRF information storing module 172 stores information to map a particular VR to a session. For example, VRF information storing module 172 obtains an indication that a new session has been established and that traffic has been received via a VR (e.g., ingress traffic from a client connected to a network via a VR). VRF information storing module 172 stores an identifier associated with the VR (e.g., a VR identifier, such as a VR-ID, an ingress interface identifier, a zone identifier, etc.) in association with an identifier for the particular session (e.g., session identifier). In some embodiments, VRF information storing module 172 stores the routing information (e.g., an indication that a particular VR is associated with a particular session) in mappings of VR IDs to session IDs 174. Mappings of VR IDs to session IDs 174 may be stored in database 160.

In some embodiments, VRF information storing module 172 additionally stores routing information for a VR, such as a routing table that maps client identifiers to IP addresses for the IP address space associated with the VR. In some embodiments, VRF information storing module 172 stores the routing information (e.g., an indication of an IP address for a client connected to the network via a particular VR) in mappings of client address to VR IDs 178. Mappings of client address to VR IDs 178 may be stored in database 160.

Virtual router forwarding service 170 uses VRF information lookup module 176 to determine a routing for network traffic, such as ingress S2C traffic (e.g., S2C traffic responsive to a particular C2S flow) and to provide the routing, such as in connection with causing the network traffic to be properly routed to the applicable client. In response to receiving an indication that ingress S2C traffic is to be routed, VRF information lookup module 176 can perform a lookup for the VR associated with the particular session corresponding to the S2C traffic. For example, the S2C traffic may carry a session identifier and VRF information lookup module 176 uses the session identifier in connection with performing a lookup against mappings of VR IDs to session IDs 174 to obtain the VR identifier associated with the particular session. In response to determining the VR identifier associated with the particular session, the appropriate client address can be determined (e.g., obtained) based on the routing table for the VR. For example, the system can use the VR identifier associated with the particular session to perform a lookup in the mapping of client addresses to VR IDs to obtain the address for the client. Accordingly, the system can route the S2C traffic based on routing the traffic through the appropriate VR to the applicable client.

Network traffic classification service 138 may comprise an anomaly detector 146 (e.g., configured to detect anomalies in network traffic, file samples obtained by intercepting traffic, DNS traffic, or DNS records, etc.), a decision engine 152 (e.g., configured to predict whether network traffic, intercepted file samples, DNS traffic is malicious or whether a DNS record is DNS hijacked), domain profiles 156, and/or a similarity detector 144. In some embodiments, network traffic classification service 138 detects malicious network traffic or malware obtained from intercepted network traffic (e.g., by classifying a file sample obtained by a security entity or other network node requesting a maliciousness classification).

Network traffic classification service 138 can determine the classification for network traffic (e.g., a file sample obtained from network traffic, a DNS record, a DNS query, a DNS response, etc.) based at least in part on querying a classifier(s). The classifier that is queried to provide a classification of the network traffic sample associated with the network activity is a fingerprinting-based classifier, a heuristics-based classifier, another rule-based classifier, and/or a machine-learning based classifier. The classifier may be trained based at least in part on historical samples (e.g., samples of network traffic samples extracted from network traffic). The classifier can be trained based at least in part on a machine learning process. Examples of machine learning processes that can be implemented in connection with training the classifier(s) include random forest, linear regression, support vector machine, naive Bayes, logistic regression, K-nearest neighbors (KNN), decision trees, gradient boosted decision trees, K-means clustering, hierarchical clustering, density-based spatial clustering of applications with noise (DBSCAN) clustering, principal component analysis, a neural network (NN), XGBoost, a convolutional neural network (CNN), and LLM etc. In some embodiments, the classifier implements a CNN.

According to various embodiments, security platform 140 may receive a query from a security entity (e.g., inline firewall, such as a next generation firewall) for a real-time or offline classification of a network traffic sample, such as a file.

According to various embodiments, in response to network traffic classification service 138 classifying the network traffic sample, system 100 handles the corresponding network traffic according to a predefined policy (e.g., a security policy). For example, in response to predicting that the network traffic sample corresponds to malicious network traffic, system 100 can cause the network traffic to be blocked or quarantined, etc. As another example, system 100 can cause traffic to/from a compromised host (e.g., the client system associated with the intercepted network traffic from which the malicious domain was extracted) to be quarantined or sinkholed, etc. (e.g., at least until an administrator actively configures system 100 to proceed with permitting traffic to/from the client system, such as in response to the compromised host being remediated).

According to various embodiments, in response to network traffic classification service 138 classifying the network traffic (e.g., the network traffic sample), system 100 handles the network traffic according to a predefined policy (e.g., a security policy). For example, the system queries a traffic handling policy to determine the manner by which the network traffic (e.g., network activity for a session associated with the network traffic sample) is to be handled. The traffic handling policy may be a predefined policy, such as a security policy, etc. The traffic handling policy may indicate that network traffic associated with certain domains or having certain characteristics/profiles is to be blocked and network traffic associated with other domains or having other characteristics/profiles is to be permitted to pass through the system (e.g., routed normally). The traffic handling policy may correspond to a repository of a set of policies to be enforced with respect to network traffic. In some embodiments, security platform 140 receives one or more policies, such as from an administrator or third-party service, and provides the one or more policies to various network nodes, such as endpoints, security entities (e.g., inline firewalls), etc.

In response to determining a classification for a newly analyzed network traffic sample (e.g., a newly analyzed network traffic sample for a particular session), security platform 140 (e.g., network traffic classification service 138) sends an indication that network activity (e.g., other network traffic samples) associated with the session for which the network traffic sample is obtained are associated with, or otherwise correspond to, the determined classification. In the case that the determined classification for the network traffic sample is that the corresponding network sample (e.g., a file extracted from the network traffic) or network traffic/activity is malicious network traffic/activity, security platform 140 provides an indication that network traffic/activity associated with the session for which the network traffic sample is obtained is also to be handled according to whether the network traffic sample is malicious. Security platform 140 can provide an indication that network traffic matching the network traffic sample predicted to be malicious is to be handled as a malicious network traffic. For example, security platform 140 determines (e.g., computes) a signature or identifier for the network traffic/activity (e.g., a hash or other signature, or identifier for the corresponding network session), and sends to a network node (e.g., a security entity, an endpoint such as a client device, etc.) an indication of the classification associated with the signature (e.g., an indication whether the network traffic/activity is a malicious or non-malicious). Security platform 140 may update a mapping of signatures to network traffic sample classifications and provide the updated mapping to the security entity. In some embodiments, security platform 140 further provides to the network node (e.g., security entity, client device, etc.) an indication of a manner by which network traffic/activity matching the network traffic sample or otherwise be associated with the same session as the network traffic sample classified as malicious or matching the signature is to be handled. For example, security platform 140 provides to the security entity a traffic handling policy, a security policy, or an update to a policy.

According to various embodiments, in response to determining the maliciousness classification for a network traffic sample (e.g., obtaining the predicted maliciousness classification, such as from a classifier), network traffic classification service 138 provides an indication of the maliciousness classification, such as to the applicable security entity (e.g., the security entity that provided the network traffic sample or a security entity mediating network traffic for the session associated with the network traffic sample).

Returning to FIG. 1, suppose that a malicious individual (using client device 120) has created malware or malicious sample 130, such as a file, an input string, etc. The malicious individual hopes that a client device, such as client device 104, will execute a copy of malware or other exploit (e.g., malware or malicious sample 130), compromising the client device, and causing the client device to become a bot in a botnet. The compromised client device can then be instructed to perform tasks (e.g., cryptocurrency mining, or participating in denial-of-service attacks) and/or to report information to an external entity (e.g., associated with such tasks, exfiltrate sensitive corporate data, etc.), such as C2 server 150, as well as to receive instructions from C2 server 150, as applicable.

DNS hijacked domains, for example, can be domains that are scams, phishing sites, or sites used to distribute C2 exploits or malware.

As an illustrative example, the environment shown in FIG. 1 includes three Domain Name System (DNS) servers (122-126). As shown, DNS server 122 is under the control of ACME (for use by computing assets located within enterprise network 110), while DNS server 124 is publicly accessible (and can also be used by computing assets located within enterprise network 110 as well as other devices, such as those located within other networks (e.g., networks 114 and 116)). DNS server 126 is publicly accessible but under the control of the malicious operator of C2 server 150. Enterprise DNS server 122 is configured to resolve enterprise domain names into IP addresses, and is further configured to communicate with one or more external DNS servers (e.g., DNS servers 124 and 126) to resolve domain names as applicable.

As mentioned above, in order to connect to a legitimate domain (e.g., www.example.com depicted as website 128), a client device, such as client device 104 will need to resolve the domain to a corresponding Internet Protocol (IP) address. One way such resolution can occur is for client device 104 to forward the request to DNS server 122 and/or 124 to resolve the domain. In response to receiving a valid IP address for the requested domain name, client device 104 can connect to website 128 using the IP address. Similarly, in order to connect to malicious C2 server 150, client device 104 will need to resolve the domain, “kj32hkjqfeuo32ylhkjshdflu23.badsite.com,” to a corresponding Internet Protocol (IP) address. In this example, malicious DNS server 126 is authoritative for *.badsite.com and client device 104's request will be forwarded (for example) to DNS server 126 to resolve, ultimately allowing C2 server 150 to receive data from client device 104.

Data appliance 102 is configured to enforce policies regarding communications between client devices, such as client devices 104 and 106, and nodes outside of enterprise network 110 (e.g., reachable via external network 118). Examples of such policies include ones governing traffic shaping, quality of service, and routing of traffic. Other examples of policies include security policies such as ones requiring the scanning for threats in incoming (and/or outgoing) email attachments, website content, information input to a web interface such as a login screen, files exchanged through instant messaging programs, and/or other file transfers, and/or quarantining or deleting files or other exploits identified as being malicious (or likely malicious). In some embodiments, data appliance 102 is also configured to enforce policies with respect to traffic that stays within enterprise network 110. In some embodiments, a security policy includes an indication that network traffic (e.g., all network traffic, a particular type of network traffic, etc.) is to be classified/scanned by a classifier that implements a pre-filter model, such as in connection with detecting malicious or suspicious domains, detecting parked domains, or otherwise determining that certain detected network traffic is to be further analyzed (e.g., using a finer detection model).

In some embodiments, security platform 140 comprises a network traffic classifier that provides to a security entity, such as data appliance 102, an indication of the traffic classification. For example, in response to detecting the C2 traffic, network traffic classifier sends an indication that the domain traffic corresponds to C2 traffic to data appliance 102, and the data appliance 102 may in turn enforce one or more policies (e.g., security policies) based at least in part on the indication. The one or more security policies may include isolating/quarantining the content (e.g., webpage content) for the domain, blocking access to the domain (e.g., blocking traffic for the domain), isolating/deleting the domain access request for the domain, ensuring that the domain is not resolved, alerting or prompting the user of the client device the maliciousness of the domain prior to the user viewing the webpage, blocking traffic to or from a particular node (e.g., a compromised device, such as a device that serves as a beacon in C2 communications), etc. As another example, in response to determining the application for the domain, the network traffic classifier provides to the security entity with an update of a mapping of signatures to applications (e.g., application identifiers).

FIG. 2 is a block diagram of an environment for performing inter-virtual router forwarding according to various embodiments. In some embodiments, system 200 is implemented at least in part by system 100. System 200 may implement at least part of one or more of processes 600-1500 of FIGS. 6-15.

In the example shown, system 200 comprises a routing entity 205 that handles C2S traffic and S2C traffic. Routing entity 205 that is configured to route traffic from one or more clients to the internet (e.g., a server via the internet) and to route traffic received from the internet (e.g., from a server providing a service via the internet) to the appropriate client behind (e.g., connected to) the routing entity 205. In some embodiments, routing entity 205 is a firewall such as a next generation firewall. As an example, routing entity 205 corresponds to a branch (e.g., branch 1).

According to various embodiments, routing entity 205 is configured to run a plurality of virtual routing instances. In the example shown, routing entity 205 supports three virtual routers: VR1 210, VR2 215, and VR3 220. The various virtual routers can comprise interfaces (e.g., ingress interfaces) that are associated with different zones, for example, an ingress interface of VR1 210 is associated with zone 1, an ingress interface of VR2 215 is associated with zone 2, and an ingress interface of VR3 220 is associated with zone 3. However, in various embodiments, routing entity 205 can support various other numbers of virtual routers. The IP address spaces for two or more of the virtual routers supported by routing entity 205 can be at least partially overlapping. As illustrated in FIG. 2, each of VR1 210, VR2 215, and VR3 220 have an IP address 10.1.1.5 in their respective IP address spaces. For example, client 230 connects to the network via VR1 210, client 235 connects to the network via VR2 215, and client 240 connects to the network via VR3 220. Each of client 230, client 235, and client 240 have an IP address of 10.1.1.5 when connecting to their respective virtual routers.

In some embodiments, the various virtual routers can correspond to different zones, for example, VR1 210 is associated with zone 1, VR2 215 is associated with zone 2, and VR3 220 is associated with zone 3.

Routing entity 205 (or specifically, an applicable virtual router) stores a mapping of clients connected through a particular virtual router and the corresponding addresses for the clients. For example, the mapping may comprise an indication of an IP address for the client and/or port via which the client connects to the virtual router. The system may also store a mapping of virtual routers to corresponding clients (e.g., a mapping of virtual router identifiers to client identifiers) to store an indication of the particular virtual router via which a particular client is connected to the system.

In some embodiments, in response to routing entity 205 (or specifically, an applicable virtual router) receiving C2S traffic from a client connected via a virtual router, the system (e.g., routing entity or the particular virtual router via which the client connected to the network) determines session associated with the C2S traffic, for example, by determining (e.g., obtaining) a session identifier for the particular session. Routing entity 205 stores, in association with the session identifier, an indication of a virtual router via which the C2S traffic was received. Thus, routing entity 205 can maintain a mapping of sessions to VRs, which can then be used in conjunction with the client address at the VR (e.g., according to a routing table for the VR) to route the return traffic.

As an illustrative example, traffic from client 230 ingresses via VR1 210. VR1 210 has the identifier zone 1 (e.g., the ingress interface identifier mapped to zone 1), and thus the session for the communication between client 230 and VR1 210 is mapped to the VR1 210 identifier (e.g., the ingress interface for zone 1, the zone identifier for zone 1, etc.). Routing entity 205 stores the VR1 210 identifier (e.g., the ingress interface for zone 1) in association with the session identifier for the session for which client 230 communicates with VR1 210. This association is used to denote that return traffic for that particular session is to be routed through VR1 210. Similarly, traffic from client 235 ingresses via VR2 215. VR2 215 has the identifier zone 2 (e.g., the ingress interface identifier mapped to zone 2), and thus the session for the communication between client 235 and VR2 215 is mapped to the VR2 215 identifier (e.g., the ingress interface for zone 2). Traffic from client 240 ingresses via VR3 220. VR3 220 has the identifier zone 3 (e.g., the ingress interface identifier mapped to zone 3), and thus the session for the communication between client 240 and VR3 220 is mapped to the VR3 220 identifier (e.g., the ingress interface for zone 3).

According to various embodiments, the system uses the stored association between session identifier and VR identifier to differentiate traffic for different VRs.

Routing entity 205 egresses the C2S traffic to route the C2S traffic to the intended destination. In some embodiments, routing entity 205 implements VR 225 to interface (e.g. communicate) with the internet. In connection with egressing the C2S traffic via VR 225, the system (e.g., routing entity 205 and/or VR 225) can perform SRC NAT, for example, to replace the source address that denoted the client via which the C2S originated or the VR via which the client connected to the network with the address of VR 225 (or routing entity 205, generally). In response to performing the SRC NAT, VR 225 egresses the C2S traffic to the appropriate destination via internet 250.

According to various embodiments, routing entity 205 routes ingress S2C traffic based at least in part on the mappings of session identifier to VR identifiers. Using the example shown, routing entity 205 receives S2C traffic from the internet 250 (e.g., from a server providing a service via internet 250) via VR 225. For example, because of the SRC NAT performed when egressing the C2S traffic, the return S2C traffic has a destination location associated with VR 225. In response to receiving the ingress S2C traffic, the system (e.g., routing entity 205) determines the session with which the S2C traffic is associated. For example, the routing entity 205 obtains (e.g., extracts) a session identifier from the S2C traffic. In response to obtaining the session identifier, the system (e.g., routing entity 205) can use the session identifier to perform a lookup against the mapping of session identifiers to VR identifiers to determine (e.g., obtain) the VR identifier associated with the particular session. In the example shown, for S2C traffic that is return traffic for the C2S traffic communicated by client 230, routing entity 205 performs a lookup based on the session identifier obtained from the S2C traffic and determines that the particular session is mapped to VR1 210. Thus, routing entity 205 routes the S2C return traffic to VR1 210. The system (e.g., VR1 210 and/or routing entity 205) can then determine the particular destination address to which to route the S2C return traffic based at least in part on the session identifier. For example, the system uses the session identifier to perform a lookup against the routing table for VR1 210 and determines that the destination for the particular session is client 230 (e.g., IP address 10.1.1.5). VR1 210 then routes the traffic to client 230.

FIG. 3 is a block diagram of an environment for performing inter-virtual router forwarding according to various embodiments. In some embodiments, system 300 is implemented at least in part by system 100. System 300 may implement at least part of one or more of processes 600-1500 of FIGS. 600-1500.

Various embodiments implement the techniques described herein for SDWAN infrastructure, such as the infrastructure for system 300. SDWAN infrastructure is further described in U.S. Patent Application Publication No. 2022/0103466, published on Mar. 31, 2022, the entirety of which is hereby incorporated by reference for all purposes. In the example shown, system 300 comprises a hub site 355 that supports connections between the network (e.g., the HQ network) and various branch sites, such as branch 1 325, branch 2 330, branch 3 335, and/or branch 4 340. Each of the branch sites may support connections to the network for a plurality of clients. Each branch site can connect to hub site 355 via a particular virtual router. For example, branch 1 site 325 and branch 2 site 330 connect to hub site 355 via VR1 345. Similarly, branch 3 site 335 and branch 4 site 340 connect to hub site 355 via VR2 350.

In some embodiments, system 300 supports VR1 345 and VR2 350 having overlapping IP address spaces. For example, the IP address 10.1.1.5 is used by both (i) client 305 that connects to hub site 355 via branch 1 site 325 and VR1 345, and (ii) client 315 that connects to hub site 355 via branch 3 site 335 and VR2 350. The system 300 (e.g., VR1 345) can store in the routing table for VR1 345 the mapping of the client 305 to the destination address of 10.1.1.5. Similarly, system 300 (VR2 350) can store in the routing table for VR2 350 the mapping of client 315 to the destination address of 10.1.1.5.

When ingress C2S traffic is received at hub site 355, the system 300 (e.g., hub site 355, or a routing service for hub site 355) can determine the association between a particular session (e.g., the session via which a particular client is communicating with the network) and the virtual router via which the C2S traffic was ingress. In response to determining the association, the system can store the association, such as in a mappings of session identifiers to virtual router identifiers. As an illustrative example, client 305 connects to branch site 325 and thus hub site 355 via VR1 345 for a particular session and communicates C2S traffic. When the system (e.g., hub site 355) receives the C2S traffic, the system (e.g., hub site 355 or a routing service for hub site 355) stores a session identifier for the particular session in association with the virtual routing identifier for VR1 345. Similarly, client 315 connects to branch site 335 and thus hub site 355 via VR2 350 for a particular session and communicates C2S traffic. When the system (e.g., hub site 355) receives the C2S traffic, the system (e.g., hub site 355 or a routing service for hub site 355) stores a session identifier for the particular session in association with the virtual routing identifier for VR2 350.

Hub site 355 (e.g., the routing service associated with hub site 355) can egress the C2S traffic to the internet 365, for example, to a server that provides a service via internet 365. In some embodiment, the system egresses traffic from hub site 355 via a virtual router, such as VR 360 which may be a virtual router dedicated to interfacing with the internet 365. According to various embodiments, in connection with egressing the C2S traffic, the system 300 (e.g., hub site 355, VR 360, or the routing service for hub site 355) performs an SRC NAT to replace the source identifier for the client from which the C2S originated with the address for hub site 355, or particularly, the address for VR 360 via which the C2S traffic egresses the network and to which return traffic is to be directed for routing. Carrying on with this example, when the server returns S2C traffic via internet 365, the server uses the address for hub site 355 (or specifically VR 360) based on the source identifier used after the system performs the SRC NAT for the corresponding C2S traffic.

In response to receiving the return S2C traffic, hub site 355 determines the appropriate VR through which the S2C traffic is to be sent in connection with forwarding the S2C traffic to the corresponding client. In some embodiments, hub site 355 determines the session with which the particular S2C traffic (e.g., traffic flow) is associated. For example, hub site 355 can obtain (e.g., extract) session information (e.g., a session identifier) based at least in part on the S2C traffic. Hub site 355 uses the session information to determine the VR associated with the session (e.g., the zone via which the corresponding C2S traffic flowed). In response to obtaining the session information (e.g., the session identifier), the system (e.g., hub site 355) can use the session information to perform a lookup against the mapping of session information to VR identifiers to determine (e.g., obtain) the VR identifier associated with the particular session. In the example shown, for S2C traffic that is return traffic for the C2S traffic communicated by client 310, hub site 355 performs a lookup based on the session identifier obtained from the S2C traffic and determines that the particular session is mapped to VR1 345. Thus, hub site 355 routes the S2C return traffic to VR1 345. The system (e.g., VR1 345 and/or hub site 355) can then determine the particular destination address to which to route the S2C return traffic based at least in part on the session identifier. For example, the system uses the session identifier to perform a lookup against the routing table for VR1 345 and determines that the destination for the particular session is client 310 (e.g., IP address 11.1.1.5). VR1 345 then routes the traffic to branch 2 site 330 and in turn to client 310.

In some embodiments, in response to determining the appropriate VR through which to send the return S2C traffic, the system determines the particular branch through which to send the return S2C traffic. For example, if the client to which the S2C traffic is to be forwarded sits behind a branch (e.g., connects to the network via a branch) and the branch is serviced by the VR, then the system (e.g., VR1 345) can first determine that the traffic to be routed to client 310 is to be sent via branch 2 330. The system can determine the branch based at least in part on the destination address information stored in the routing tables (e.g., VR1 345 routing tables) for the corresponding session. Branch 1 site 325 and branch 2 330 can sit behind VR1 345 (e.g., are both serviced by VR1 345). Accordingly, branch 1 site 325 and branch 2 330 have non-overlapping IP addresses (e.g., non-overlapping IP address spaces). Thus, upon determining the destination address for the S2C flow based on the routing tables lookup using the session information, the system can determine that the destination address is serviced by a particular branch (e.g., branch 2 site 330 in the case that the S2C traffic is to be forwarded to client 310). The system therefore determines the appropriate routing based on the session information and, in the example above, forwards the S2C traffic through VR1 345 to branch 2 330 and then to client 310.

In modern SD-WAN (Software-Defined Wide Area Network) deployments, virtual routing and forwarding (VRF) instances are commonly employed to provide logical network segregation. Some architectures allow multiple VRFs at the SD-WAN hub, enabling clients to use overlapping IP address spaces while enforcing security policies and routing isolation at the hub. However, these systems generally assume that each SD-WAN branch site operates within a single VRF context. As enterprises and service providers seek greater scalability, multi-tenancy, and logical separation across distributed network infrastructure, there is an increasing demand to support multiple VRFs at the branch level as well (e.g., each potentially configured with overlapping IP address space and requiring independent routing and policy control).

Various embodiments extend the functionality of the previously described system to enable support for multiple virtual routers (VRs) at SD-WAN branch locations, not just the hub. According to various embodiments, traffic from a VR at a branch is encapsulated with a globally unique VR identifier (VR ID), which is orchestrated across the SD-WAN topology through a centralized controller. The encapsulated traffic is transmitted over a common tunnel interface to the hub. Upon receipt, the hub extracts the VR ID and determines a corresponding security zone associated with that VR. In contrast to related art systems where zones are derived solely from ingress interfaces, the system according to various embodiments introduces a novel construct wherein zones are derived from VR identifiers, thereby enabling zone-based session management and security policy enforcement even when traffic from multiple VRs arrives over the same physical interface.

In some embodiments, the system additionally introduces a dummy SD-WAN interface model within each VR, allowing routing protocols such as BGP to establish independent control-plane peerings for each VR instance over shared physical or tunnel infrastructure. While these dummy interfaces serve as logical endpoints in the control plane, the system rewrites the associated forwarding paths in the data plane to point directly to the actual tunnel virtual interfaces (VIFs). This allows for efficient routing and policy enforcement across a high number of coexisting VRs while minimizing resource overhead and avoiding the need to instantiate separate tunnel interfaces per VR.

By introducing per-VR encapsulation, VR-based zone derivation, dummy interfaces, and globally orchestrated VR IDs, the system enables true multi-VR support across both hub and branch SD-WAN nodes. This architecture allows entities with overlapping IP addressing requirements to coexist securely and efficiently across a shared SD-WAN overlay, and it supports high-scale, logically separated routing and security policies across diverse enterprise and multi-tenant deployments.

FIG. 4 is a block diagram of an environment for performing inter-virtual router forwarding according to various embodiments. In some embodiments, system 400 is implemented at least in part by system 100. System 400 may implement at least part of one or more of processes 600-1500 of FIGS. 600-1500.

According to various embodiments, the system extends virtual routing and forwarding capabilities to SD-WAN branch devices, enabling each branch to operate multiple virtual routers (VRs) concurrently. This allows for complete logical separation of traffic, routing infrastructure, and security enforcement per VR at the branch level. Multiple SD-WAN branches may each host multiple VRs, and the same virtual router identifier (e.g., VR1, VR2) may be instantiated across different branches to represent logically consistent routing domains (e.g., departmental or tenant-based separation) even when clients in those VRs use overlapping IP address ranges.

In some embodiments, to maintain end-to-end traffic separation and consistent routing context across a shared SD-WAN fabric, the system implements a globally unique virtual router identifier (“VR ID”) for each VR. A centralized orchestration system assigns and distributes VR IDs across the SD-WAN deployment (including hub and branch nodes). During tunnel encapsulation, SD-WAN branch devices insert the VR ID into the encapsulated header of outbound packets (e.g., using the VNI field of a Geneve header). When the encapsulated traffic is received at the hub, the system (e.g., the hub) extracts the VR ID and maps it to a corresponding VR context at the hub. This enables the hub to perform VR-specific route lookups and enforce policies without requiring distinct tunnel interfaces per VR.

In contrast to related art systems where the ingress interface determines the zone associated with a firewall session, systems according to various embodiments implement mechanism whereby the zone is derived from the VR ID embedded in the encapsulated traffic. In some embodiments, administrators may configure a zone association per VR, such that VR1 may be assigned to a first zone and VR2 to a second zone, regardless of the shared physical interface through which the packets are received. When the firewall (e.g., at the hub) decapsulates a packet and determines the VR ID, it assigns the zone for the session based on the configured mapping between the VR ID and its associated zone. The session is then processed according to the zone-specific security policy, enabling consistent enforcement even for traffic received on the same tunnel interface.

In some embodiments, to facilitate per-VR control plane separation over shared tunnel infrastructure, the system implements (e.g., introduces) dummy SD-WAN interfaces within each VR. These dummy interfaces act as logical containers that reference the actual physical SD-WAN interface or tunnel bundle. Routing protocols such as BGP can be instantiated independently within each VR using these dummy interfaces, satisfying the control plane requirement that peering occurs over a local interface (e.g., over an interface which is local to the VR where BGP is running). The dummy interface does not represent a unique physical path but allows control plane state to be maintained separately for each VR.

While routing protocol updates (e.g., BGP-learned routes) within each VR reference the dummy interface in the control plane, the system rewrites these routes during route publication to the data plane. Specifically, the system replaces the dummy interface next hop with the actual virtual interface (VIF) corresponding to the shared tunnel interface that carries traffic for all VRs. This allows for efficient path resolution and forwarding in the data plane, while maintaining per-VR separation in the control plane. In some embodiments, the dummy interfaces may be implemented as lightweight metadata pointers without consuming full interface resources, allowing the system to scale to support hundreds of VRs per branch.

According to various embodiments, when a packet arrives at a hub from a branch, the hub examines the encapsulated header to extract the VR ID. The system uses the VR ID to (1) determine the correct virtual router for route lookup; (2) determine the corresponding zone for policy enforcement; and (3) maintain session isolation even when the client IP addresses overlap across different VRs. When traffic is returned from the destination server (e.g., internet or inter-branch destination), the system uses stored session information to re-encapsulate the return traffic with the appropriate VR ID and route it back to the originating VR at the branch. Upon receipt, the branch extracts the VR ID from the encapsulated header and forwards the packet within the correct VR context, ensuring that routing and security policies remain consistent across the path.

In this architecture, both inter-branch and branch-to-internet traffic flows maintain strict logical separation via VR-aware encapsulation and per-VR zone and policy assignment. A branch may, for example, host VRs for different business units (e.g., HR, finance, operations), each with its own overlapping IP subnet (e.g., 10.1.1.0/24). These VRs may independently peer with corresponding VRs at other branches or route traffic through a common DIA VR at the hub. Because all traffic carries the VR ID and is handled according to that context, overlapping address spaces and distinct policies can coexist on the same physical infrastructure.

By supporting per-branch multi-VR instances, VR-based session and zone mapping, dummy SD-WAN interfaces for control plane peering, and encapsulated VR identity propagation, the system enables high-scale, logically separated SD-WAN environments. These enhancements allow enterprises and service providers to deploy flexible, tenant-aware architectures while reusing IP address space and minimizing infrastructure duplication.

Returning to the example shown, system 400 is configured for routing traffic in a software-defined wide area network (SD-WAN) environment that supports multiple virtual routers (VRs) per branch and hub. System includes a hub node, for example, hub 440 (e.g., a next-generation firewall or SD-WAN headend device), and a plurality of branch nodes (also referred to herein as spokes) (e.g., branch 1 418, branch 2 426, branch 3 434, etc.), each connected to the hub 440 via secure tunnel interfaces.

As shown, a hub 440 includes a plurality of virtual routers 438, including VR1, VR2, and a default internet access VR (DIA VR) 442. Each of these virtual routers may be configured with a zone assignment (e.g., VR1→Zone A, VR2→Zone B) to facilitate session identification and policy enforcement based on VR identity. A centralized orchestrator (e.g., not shown) assigns a globally unique virtual router identifier (VR ID) for each VR instance across the SD-WAN topology and ensures consistent VR ID mappings across hub 440 and branch devices (e.g., branch 1 418, branch 2 426, branch 3 434, etc.). In some embodiments, the centralized orchestrator is a system or service implemented at hub 440. In some embodiments, the centralized orchestrator is a system or service implemented as a cloud service.

Multiple branch nodes (e.g., branch 1 418, branch 2 426, branch 3 434, etc.) are each configured with multiple virtual routers (e.g., VR1 414 and VR2 416 on branch 1 418; VR1 422 and VR2 424 on branch 2 426; and VR1 430 and VR2 432 on branch 1 434). One or more clients 402, 404, 406, 408, 410, and 412, etc., are connected behind the respective VRs. In some embodiments, clients behind different VRs (even across different branches) may have overlapping IP addresses (e.g., 10.1.1.5) due to logical segmentation. In the example shown, client 402 has an IP address of 10.1.1.5; and client 408 has an IP address of 10.1.1.5. Similarly, client 404 has an IP address of 10.1.1.10; and client 410 has an IP address of 10.1.1.10. Similarly, client 406 has an IP address of 11.1.1.5; and client 412 has an IP address of 11.1.1.5.

Each branch node includes a shared SD-WAN tunnel interface used to connect to the hub 440. For example, branch 1 418 comprises VR1/VR2 interface 420; branch 2 426 comprises VR1/VR2 interface 428; and branch 3 434 comprises VR1/VR2 interface 436. According to various embodiments, each virtual router at the branch (e.g., VR1 414 and VR2 416 at branch 1 418, etc.) includes a corresponding dummy SD-WAN interface which logically points to the shared tunnel interface (VR1/VR2 interface 420). These dummy interfaces allow independent instantiation of routing protocols such as BGP within each VR. BGP sessions established via the dummy interfaces advertise and receive routing updates per VR context.

When traffic from a client (e.g., client 402) is forwarded from a branch (e.g., branch 1 418) to the hub 440, the corresponding VR (e.g., VR1 414) performs encapsulation of the outbound packet with a tunnel header that includes the VR ID assigned to VR1 414. In some embodiments, the tunnel header comprises a Geneve header with the VR ID encoded in the VNI field. The encapsulated traffic is then transmitted over the shared tunnel interface (e.g., VR1/VR2 interface 420) to the hub 440.

Upon receipt of the encapsulated traffic, the hub 440 decapsulates the packet and extracts the VR ID. The VR ID is used to determine the correct virtual router (e.g., VR1 414) for route lookup, and to assign a zone for the session based on a mapping of VR IDs to zones maintained by the system. The system then performs security policy enforcement and session tracking based on the VR-derived zone. This allows traffic from different VRs (e.g., even when arriving over the same physical or logical interface) to be independently tracked and filtered.

In the reverse direction, when return traffic is generated (e.g., from an internet server such as via web 444, or another branch), the hub 440 encapsulates the response with the original VR ID associated with the client session. The return traffic is forwarded back over the tunnel to the appropriate branch node (e.g., branch 1 418 in the example above). The receiving branch extracts the VR ID and forwards the packet into the correct virtual router (e.g., VR1 414 in the example above), where it is delivered to the intended client (e.g., client 402).

According to various embodiments, the system maintains mappings of session identifiers to VR IDs and uses these mappings to ensure session continuity, proper routing, and zone-specific policy enforcement across multi-VR environments. The dummy SD-WAN interfaces used in control plane configuration (e.g., BGP) are dereferenced in the data plane, where routing next hops are resolved directly to underlying virtual interface functions (VIFs) representing the actual tunnel endpoints.

This architecture enables support for a high number of VRs per branch (e.g., 20 or more), while allowing clients in each VR to operate in logically isolated domains with overlapping IP addresses. It also allows centralized orchestration of routing domains and security zones, enabling multi-tenant and departmental segmentation over a shared SD-WAN infrastructure.

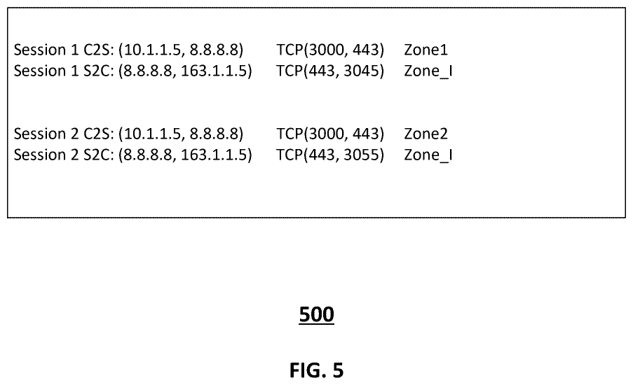

FIG. 5 is an example of routing information for inter-virtual router forwarding according to various embodiments. The example shown illustrates routing information 500 for various sessions. This routing information can be used in connection with determining the appropriate routing for C2S and S2C traffic flow based on the session information.

The routing information includes IP address information, comprising a source IP address and a destination IP address. The routing information for the C2S further include port information, comprising a source port and a destination port. In some embodiments, the system uniquely identifies C2S traffic based on the zone information (e.g., a zone identifier) stored in association with the session (e.g., Zone 1 in the case of session 1 in the illustrated example). The system uniquely identifies the S2C traffic based at least in part on the port number. The system determines the port for the VR via which the traffic is to be forwarded, and then uses the routing tables/information for the particular port/VR serviced by the port/VR to determine the client address associated with the session.

In some embodiments, traffic to the firewall becomes unique because the various zones or various VRs are expected to be different. Each VR or zone has different interfaces (e.g., different ports through which traffic flows). According to various embodiments, the ingress interface in different VRs have unique zones in case any two VRs have overlapping IP address spaces. Each zone can have unique ports at the VRs. For example, there is no overlap in interfaces between VRs with respect to VRs of different zones. Because zone information (e.g., zone identifiers) can be used to identify a zone with which traffic is associated (e.g., the zone via which C2S traffic ingresses the firewall), the system can support overlapping IP address spaces (e.g., overlapping subnets). Therefore, clients from two different VRs (e.g., zones) can have the same IP address, and the ports/interfaces through which traffic flows through the firewall is used to distinguish between these two clients to appropriately route the information.

According to various embodiments, whichever interface (e.g., port corresponding to a VR) via which a packet enters, the zone information (e.g., zone identifier) for the interface is stored as part of the session. When the C2S traffic is egressed the port via which the traffic ingresses to the routing service is changed to a common port (e.g., port 3000 for zone_I in the illustrated example) so that internet traffic comes from the same internet port (e.g., the servers return the traffic to a destination address for the common port). However, as shown in the example, for return S2C traffic, the destination port used is not the common port 3000. Rather, the destination port used for the return S2C traffic is the port associated with the zone from which the corresponding C2S traffic flowed. In the example shown, port 3045 corresponds to zone 1 and port 3055 corresponds to zone 2. The system (e.g., the firewall) can make this common port to zone-specific port translation when receiving the S2C traffic and determining the routing for the S2C traffic flow.

In the example shown, session 1 comprises routing information for C2S traffic flow. The source IP address for the C2S traffic is 10.1.1.5 and the destination IP address (e.g., the address for the server) is 8.8.8.8. For session 1 the source port is 3000 and the destination port is 443. The destination port 443 in the C2S traffic corresponds to a common port for the routing service (e.g., the common port for a hub site). The routing service uses the common port to egress C2S traffic to the appropriate internet destination (e.g., the server) and translates this to the zone-specific port when return S2C traffic is received.

FIG. 6 is a flow diagram of a method for routing traffic according to various embodiments. In some embodiments, process 600 is implemented at least in part by system 100 of FIG. 1, system 200 of FIG. 2, system 300 of FIG. 3, and/or system 400 of FIG. 4.

At 605, the system stores an ingress VRF information in connection with a client-server flow information for a particular session. For example, the system stores a virtual router identifier in association with the particular session (e.g., in a mappings of session identifiers to virtual router identifiers. The association between the virtual router identifier and the particular session is used to denote the virtual router (e.g., corresponding to the virtual router identifier for the particular session) via which return traffic (e.g., S2C traffic) is to be routed.

At 610, the system causes the network traffic received from a server to be routed based at least in part on the VRF information. For example, the system provides an indication of the virtual router via which the network traffic is to be routed. The system may additionally provide an indication of the destination address for the particular client to which the network traffic is to be routed. The destination address for the particular client can be determined based on performing a lookup using the session identifier, for example, by performing a lookup in a mappings of session identifiers to client identifiers (which can then be used to determine the destination address from a routing table for the applicable virtual router) or a mappings of session identifiers to source addresses (e.g., the address for the client). As another example, causing the network traffic to be routed based at least in part on the VRF information includes determining the virtual router associated with the session for which the network traffic corresponds, determining the address for the client connected to the virtual router, and routing the network traffic via the virtual router to the client.

At 615, a determination is made as to whether process 600 is complete. In some embodiments, process 600 is determined to be complete in response to a determination that no further network traffic is to be routed/handled, an administrator indicates that process 600 is to be paused or stopped, etc. In response to a determination that process 600 is complete, process 600 ends. In response to a determination that 600 is not complete, process 600 returns to 605.

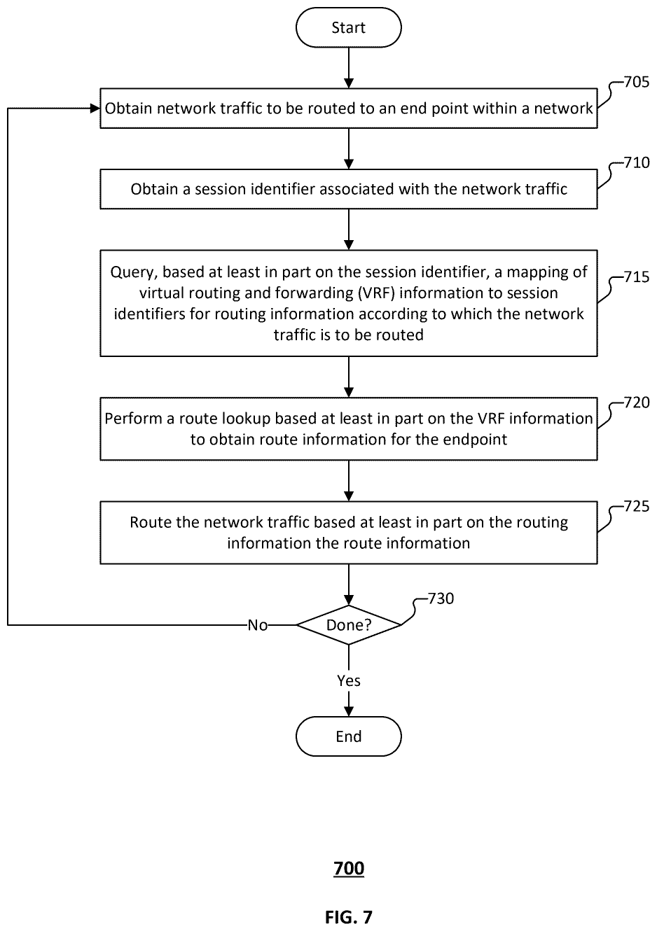

FIG. 7 is a flow diagram of a method for routing inbound network traffic from a server in connection with a server-to-client flow according to various embodiments. In some embodiments, process 700 is implemented at least in part by system 100 of FIG. 1, system 200 of FIG. 2, system 300 of FIG. 3, and/or system 400 of FIG. 4.

At 705, the system obtains the network traffic to be routed to an end point within a network (e.g., a client system connected to a network, such as behind a particular virtual router). The network traffic may be S2C traffic (e.g., return traffic for a particular C2S flow associated with a particular session). At 710, the system obtains a session identifier associated with the network traffic. At 715, the system queries, based at least in part on the session identifier, a mapping of VRF information to session identifiers for routing information according to the which the network traffic is to be routed. At 720, the system performs a route lookup based at least in part on the VRF information to obtain route information for the endpoint. For example, after determining the particular virtual router via which the network traffic is to be routed, the system can determine the address for the endpoint associated with the particular session. At 725, the system routes the network traffic based at least in part on the routing information. For example, the system uses the virtual router identifier and the end point address behind the virtual router to route the network traffic. At 730, a determination is made as to whether process 700 is complete. In some embodiments, process 700 is determined to be complete in response to a determination that no further network traffic is to be routed/handled, an administrator indicates that process 500 is to be paused or stopped, etc. In response to a determination that process 700 is complete, process 700 ends. In response to a determination that process 700 is not complete, process 700 returns to 705.

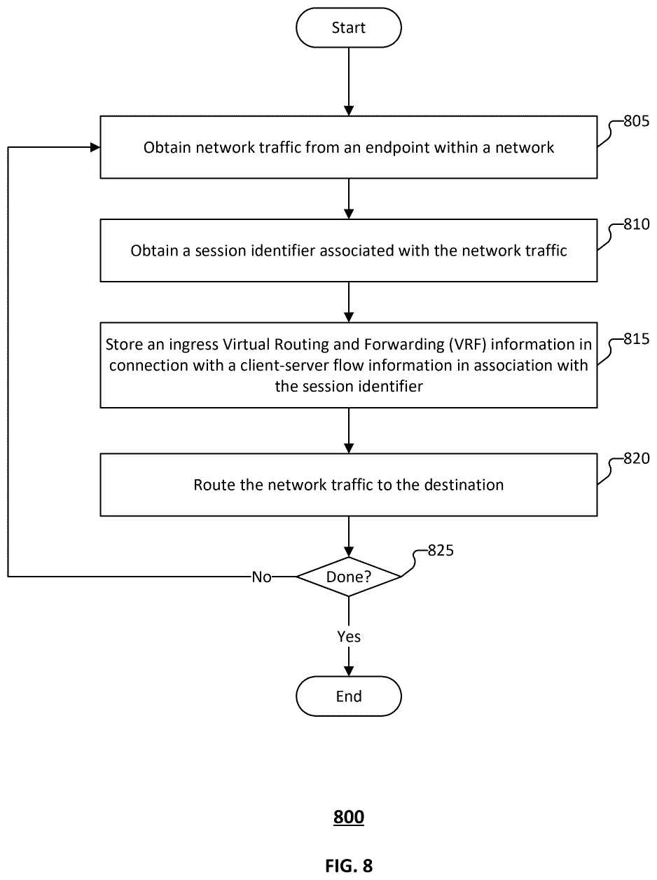

FIG. 8 is a flow diagram of a method for routing network traffic received from a client in connection with a client-to-server flow according to various embodiments. In some embodiments, process 800 is implemented at least in part by system 100 of FIG. 1, system 200 of FIG. 2, system 300 of FIG. 3, system 300 of FIG. 3, and/or system 400 of FIG. 4.

At 805, the system obtains network traffic from an endpoint within a network. At 810, the system obtains a session identifier associated with the network traffic. At 815, the system stores an ingress VRF information in connection with a client-server flow (e.g., C2S traffic) information in association with the session identifier. At 820, the system routes the network traffic to the applicable destination, such as the server or other internet endpoint. At 825, a determination is made as to whether process 800 is complete. In some embodiments, process 800 is determined to be complete in response to a determination that no further network traffic is to be routed/handled, an administrator indicates that process 800 is to be paused or stopped, etc. In response to a determination that process 800 is complete, process 800 ends. In response to a determination that process 800 is not complete, process 800 returns to 805.

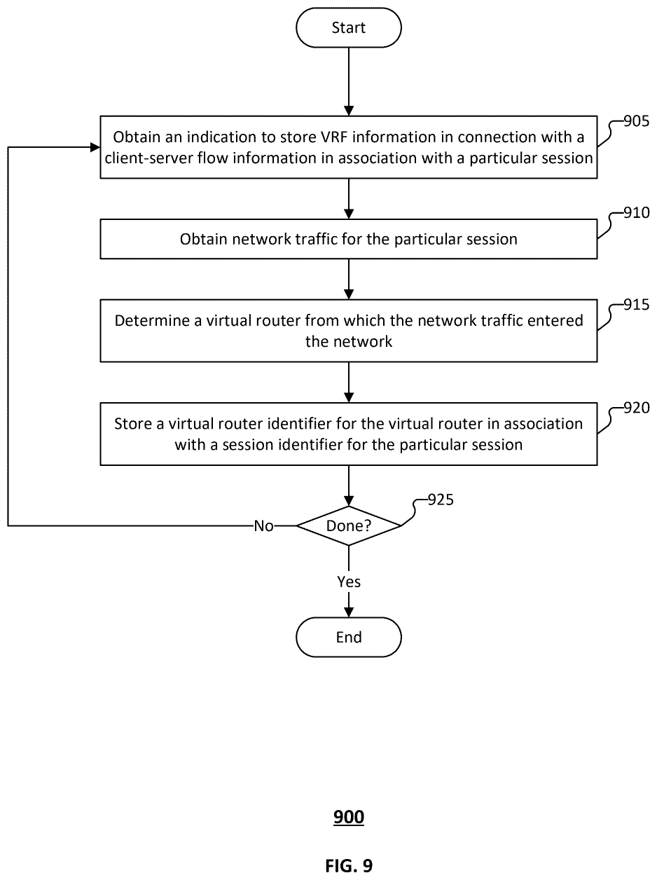

FIG. 9 is a flow diagram of a method for storing virtual router forwarding information in connection with received network traffic according to various embodiments. In some embodiments, process 900 is implemented at least in part by system 100 of FIG. 1, system 200 of FIG. 2, system 300 of FIG. 3, and/or system 400 of FIG. 4.

At 905, the system obtains an indication to store VRF information in connection with a client-server flow information in association with a particular session. At 910, the system obtains network traffic for the particular session. At 915, the system determines a virtual router from which the network traffic entered the network, for example, the virtual router via which the corresponding endpoint (e.g., client system) connected to the network to provide C2S traffic. At 920, the system stores a virtual router identifier for the virtual router in association with a session identifier for the particular session. At 925, a determination is made as to whether process 900 is complete. In some embodiments, process 900 is determined to be complete in response to a determination that no further network traffic is to be routed/handled, no further network traffic sessions are to be initiated, no further virtual router identifier is to be stored in association with a session identifier, an administrator indicates that process 900 is to be paused or stopped, etc. In response to a determination that process 900 is complete, process 900 ends. In response to a determination that process 900 is not complete, process 900 returns to 905.

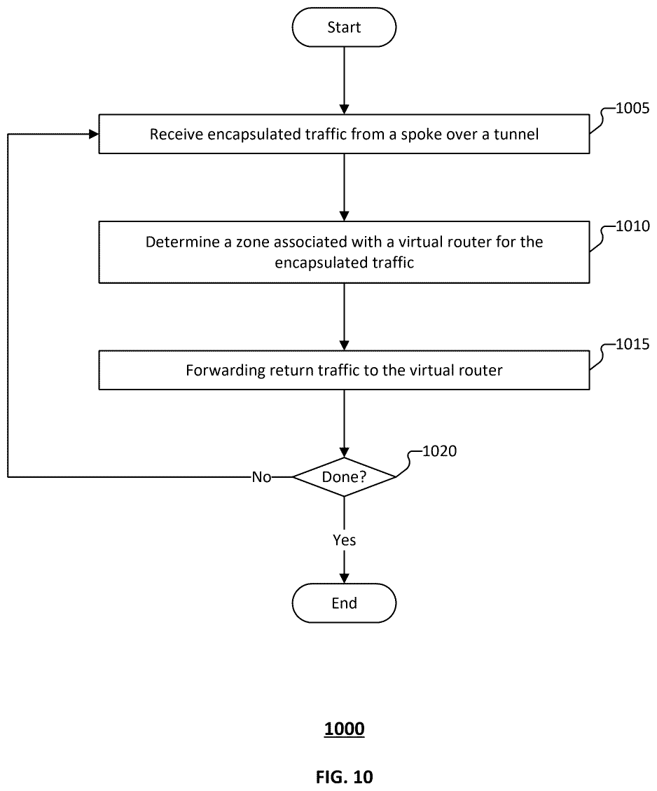

FIG. 10 is a flow diagram of a method for routing inbound network traffic from a server in connection with a server-to-client flow according to various embodiments. In some embodiments, process 1000 is implemented at least in part by system 100 of FIG. 1, system 200 of FIG. 2, system 300 of FIG. 3, system 300 of FIG. 3, and/or system 400 of FIG. 4.

Various embodiments disclose a method, system, or device for managing traffic in a Software-Defined Wide Area Network (SD-WAN) comprising a hub and multiple spoke, each spoke having one or more Virtual Routers (VRs).

At 1005, the system receives encapsulated traffic from a spoke over a tunnel. In some embodiments, the system (e.g., the hub) receives encapsulated traffic from a spoke over a tunnel. The encapsulated traffic includes a global virtual router identifier (VR ID) corresponding to a VR on the spoke.

At 1010, the system determines a zone associated with a virtual router for the encapsulated traffic. In some embodiments, the system (e.g., the hub) determines a zone associated with the VR based on the global VR ID. For example, the system extracts the global VR ID from the encapsulated network traffic (e.g., the traffic received at the hub) and performs a lookup to determine the VR associated with the VR ID.

At 1015, the system forwards return traffic to the virtual router. In some embodiments, the system (e.g., the hub) forwards return traffic to the spoke by encapsulating the return traffic with the global VR ID corresponding to the VR on the spoke.

At 1020, the system determines whether process 1000 is complete. In some embodiments, process 1100 is determined to be complete in response to a determination that no further network traffic is to be routed/handled, no further network traffic sessions are to be initiated, an administrator indicates that process 1000 is to be paused or stopped, etc. In response to a determination that process 1000 is complete, process 1000 ends. In response to a determination that process 1000 is not complete, process 1000 returns to 1005.

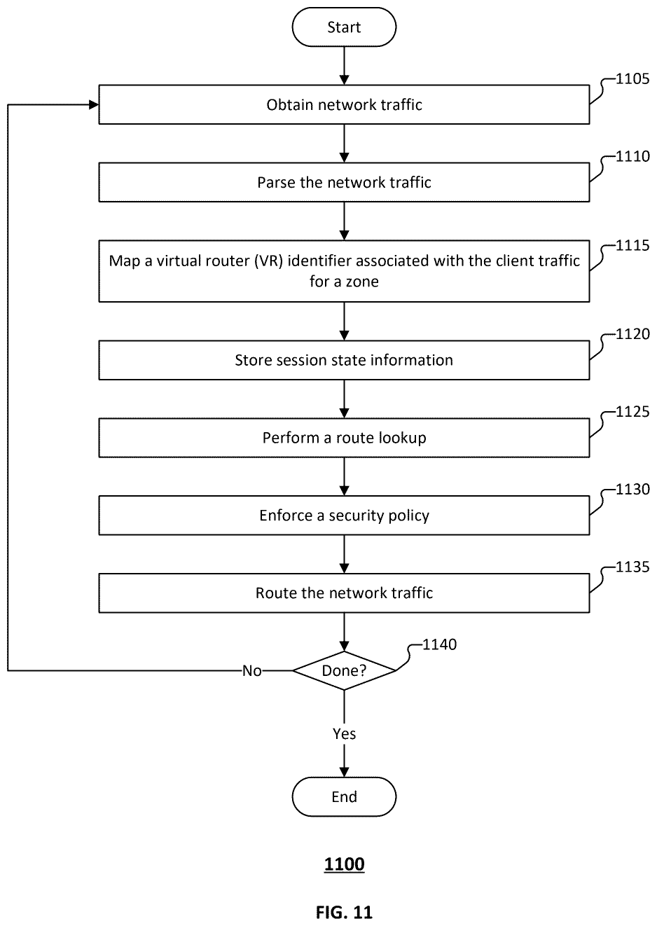

FIG. 11 is a flow diagram of a method for handling ingress traffic at a hub using an encapsulated virtual router identifier according to various embodiments. In some embodiments, process 1100 is implemented at least in part by system 100 of FIG. 1, system 200 of FIG. 2, system 300 of FIG. 3, system 300 of FIG. 3, and/or system 400 of FIG. 4.

According to various embodiments, at least part of process 1100 is executed by a centralized routing and security device (e.g., a hub node such as a next-generation firewall or SD-WAN gateway) that receives encapsulated traffic from a branch over a shared SD-WAN tunnel interface. The encapsulated traffic includes a globally unique virtual router identifier (VR ID) corresponding to the source virtual router at the branch. The hub extracts the VR ID, determines a network zone associated with the virtual router, and applies zone-specific routing and security policies. This allows the hub to maintain routing and policy separation for multiple virtual routers (e.g., even when traffic shares a common tunnel interface and includes overlapping IP address space).

Returning to the example shown, at 1105, the system obtains network traffic. In some embodiments, the hub device receives encapsulated client traffic, for example, over a shared tunnel interface. This encapsulated packet originates from a virtual router instance on a branch node and is transported across a VPN overlay tunnel, which may be implemented using a format such as Geneve or VXLAN. The encapsulated packet includes an inner payload and a header that identifies a global VR ID corresponding to the virtual router from which the traffic was transmitted.

At 1110, the system parses the network traffic. In some embodiments, the hub parses the encapsulated packet and extracts the VR ID from a field in the tunnel header (e.g., a VNI field in the Geneve header). The VR ID is a globally unique identifier for the virtual router, assigned and distributed by a centralized SD-WAN orchestration controller.

At 1115, the system maps a virtual router (VR) identifier associated with the client traffic for a zone. In some embodiments, the hub maps the extracted VR ID to a logical network zone that has been pre-configured or provisioned by a network administrator. In some embodiments, this mapping is stored in a VR-to-zone lookup table that is periodically synchronized with the SD-WAN orchestration layer. This step decouples zone assignment from physical tunnel interfaces, allowing zone identification based purely on VR context.

At 1120, the hub stores session state information for the flow. This session state includes the tuple (e.g., a tuple comprising source IP address, destination IP address, protocol, source port, destination port, and zone, for example, a six-tuple). Notably, the zone in this context is determined based on the VR ID and not based on the tunnel ingress interface, thereby enabling correct handling of overlapping IP address spaces originating from different VRs.

At 1125, the hub performs a route lookup using the routing table associated with the identified VR. Because the VR ID maps to a specific virtual router instance at the hub, the system consults the per-VR routing context to determine the next-hop or final destination. The destination may be an internal IP prefix advertised by another branch VR, a route to an internet gateway (e.g., DIA VR), or another local segment.

At 1130, the system applies zone-specific security policies (e.g., access control rules, threat inspection, logging behavior) based on the zone associated with the VR. These policies are configured per zone and enforced before forwarding.

At 1135, the hub forwards the packet to its next destination, which may involve re-encapsulation if the destination is another branch node or routing within a service VR for direct internet access. The packet may also be subject to NAT or other post-routing transformations depending on the policy applied.

At 1140, the system determines whether process 1100 is complete. In some embodiments, process 1100 is determined to be complete in response to a determination that no further network traffic is to be routed/handled, no further network traffic sessions are to be initiated, an administrator indicates that process 1100 is to be paused or stopped, etc. In response to a determination that process 1100 is complete, process 1100 ends. In response to a determination that process 1100 is not complete, process 1100 returns to 1105.

According to various embodiments, the system (e.g., via process 1100) thereby enables the hub to distinguish traffic from different tenants or logical networks (e.g., even if the client IP address is identical) by leveraging the encapsulated VR ID and zone mapping rather than relying on tunnel interface identifiers. This provides flexible multi-tenant support and secure traffic isolation over a shared SD-WAN infrastructure.

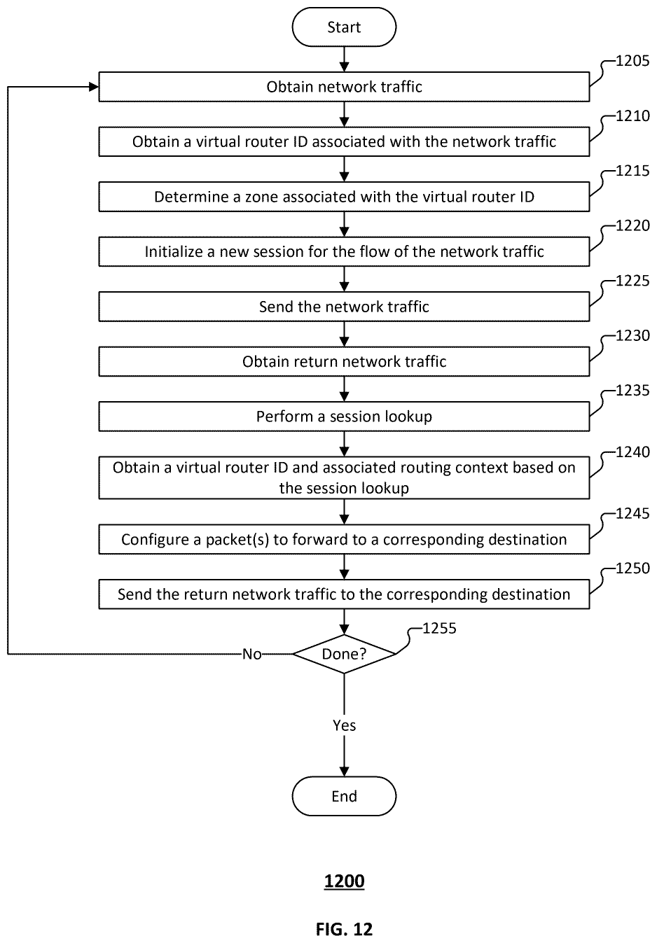

FIG. 12 is a flow diagram of a method for handling session initialization and return (S2C) path handling. In some embodiments, process 1200 is implemented at least in part by system 100 of FIG. 1, system 200 of FIG. 2, system 300 of FIG. 3, system 300 of FIG. 3, and/or system 400 of FIG. 4.

According to various embodiments, the system comprises one or more hub nodes, for example a next generation firewall. The hub node (e.g., a next-generation firewall) handles sessions in response to traffic received from a branch virtual router and the corresponding return traffic from a server (e.g., internet or internal service). The process includes receiving client-to-server (C2S) traffic tagged with a virtual router identifier (VR ID), establishing a session record associated with the VR, and later handling return server-to-client (S2C) traffic by performing a session lookup using the tuple (e.g., the six-tuple) and routing the packet back through the correct virtual router context using the VR ID. This flow allows multiple clients with overlapping source IP addresses to share tunnel infrastructure while maintaining logical separation and correct bidirectional routing.

Returning to the example shown, at 1205, the system obtains network traffic. In some embodiments, the system (e.g., the hub device) receives a C2S packet from a branch node. The C2S packet is encapsulated in a tunnel protocol (e.g., Geneve or VXLAN) and includes a VR ID in the tunnel header. The VR ID corresponds to the virtual router instance on the branch through which the client accessed the SD-WAN.

At 1210, the system obtains a VR ID associated with the network traffic. In some embodiments, the system (e.g., the hub, etc.) extracts the VR ID from the network traffic (e.g., the C2S packet). For example, the system extracts the VR ID from the encapsulated tunnel header.

At 1215, the system determines a zone associated with the VR ID. For example, the system uses the VR ID extracted from the network traffic (e.g., from the encapsulated tunnel header) and uses it to determine a corresponding logical zone and virtual router context. The zone and VR ID are recorded for session tracking purposes.

At 1220, the system initializes a new session for the flow of the C2S packet. In some embodiments, the system (e.g., the hub) initializes a new firewall session for the flow. The session record is stored in session state memory and includes a six-tuple: zone (derived from the VR ID), source IP address, destination IP address, protocol, source port, and destination port. This session uniquely identifies the flow and distinguishes it from any other flows that may share the same client IP and port but originate from a different VR.

At 1225, the system sends the network traffic. In some embodiments, the system (e.g., the hub device) forwards the C2S packet to its destination. As an example, the destination may be an internet gateway (e.g., DIA VR), another internal virtual network, or a remote service reachable via SD-WAN, etc. In some embodiments, the system implements policy enforcement and/or NAT in connection with the sending/handling of the network traffic.

At 1230, the system receives return traffic. In some embodiments, the system (e.g., the hub, etc.) receives return traffic in the server-to-client (S2C) direction. As an example, this packet(s) arrives at the hub device from an external source (e.g., internet or internal service, etc.).

At 1235, the system performs a session lookup. In some embodiments, the system (e.g., the hub) performs a session lookup using a session identifier. As an example, the session identifier may include the reversed tuple (e.g., a five-tuple, etc., for example, comprising source and destination IPs/ports, protocol, etc.) and additional session context. The system can match the session to the entry previously stored at 1215.

At 1240, the system obtains a VR ID and associated routing context based at least in part on the session context. In some embodiments, the system retrieves the VR ID and associated routing context stored with the session entry. The system then performs a routing decision based on the VR's forwarding table and prepares to forward the packet to the branch where the session originated.

At 1245, the system configures a packet(s) to forward to a corresponding destination. In some embodiments, the system (e.g. the hub) encapsulates the S2C packet(s) into a tunnel protocol (e.g., Geneve), including the same VR ID in the tunnel header that was originally received in the C2S direction. This ensures that the returning packet will be processed in the correct virtual routing context upon reaching the branch.

At 1250, the system sends the return network traffic to the corresponding destination. In some embodiments, the system sends (e.g., transmits) the encapsulated S2C packet over the SD-WAN tunnel to the branch node. Upon receipt, the branch node decapsulates the packet, extracts the VR ID, and routes the packet to the correct client based on the VR-local routing table.

At 1255, the system determines whether process 1200 is complete. In some embodiments, process 1200 is determined to be complete in response to a determination that no further network traffic is to be routed/handled, no further network traffic sessions are to be initiated, an administrator indicates that process 1200 is to be paused or stopped, etc. In response to a determination that process 1200 is complete, process 1200 ends. In response to a determination that process 1200 is not complete, process 1200 returns to 1205.

According to various embodiments, the system (e.g., via process 1200) ensures that session state and return path routing are handled in a way that preserves VR-specific isolation and correctness, even when clients across branches use overlapping IP address ranges. The use of a globally unique VR ID in both C2S and S2C directions guarantees session correlation and secure bidirectional flow handling.

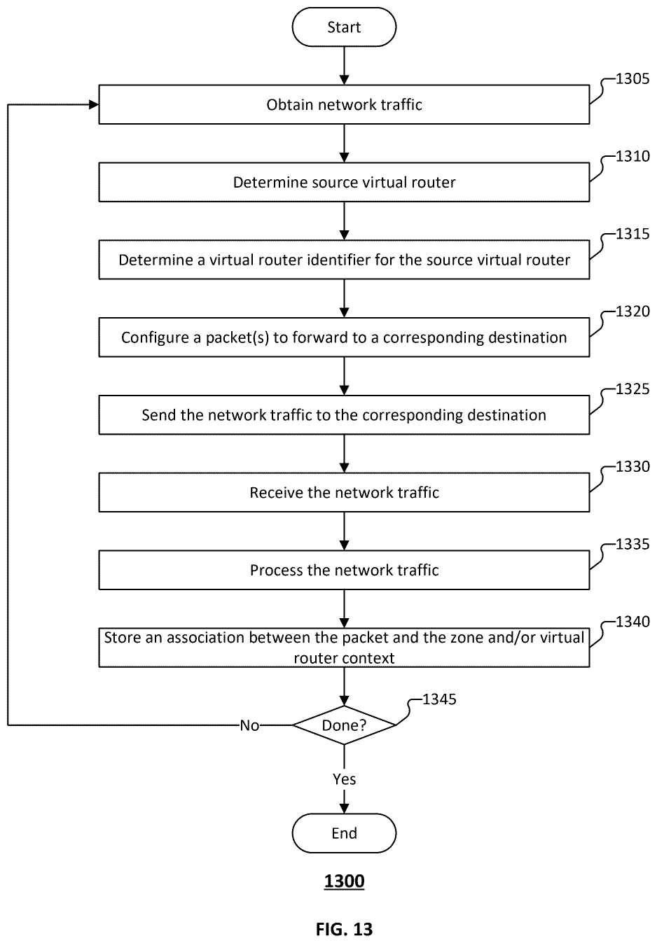

FIG. 13 is a flow diagram of a method for handling outbound traffic at a branch according to various embodiments. In some embodiments, process 1300 is implemented at least in part by system 100 of FIG. 1, system 200 of FIG. 2, system 300 of FIG. 3, system 300 of FIG. 3, and/or system 400 of FIG. 4.

According to various embodiments, the system comprises one or more branches (which each may comprise one or more branch devices. The branch device participating in an SD-WAN deployment handles outbound (client-to-server) traffic originating from a virtual router instance. In some embodiments, the branch encapsulates the outbound traffic with a tunnel header that includes a globally unique virtual router identifier (VR ID). This encapsulation enables a centralized hub (e.g., firewall or router, etc.) to distinguish between different VR contexts, even when clients in different VRs at different branches use overlapping IP address spaces. The encapsulated traffic is then transmitted across the SD-WAN tunnel to the hub for further processing.

Returning to the example shown, at 1305, the system obtains network traffic. In some embodiments, the system (e.g., a branch device) receives a packet from a local client, for example, a client within a virtual routing and forwarding instance (VRF), which may be referred to herein as a virtual router (VR). The client may be part of a local enterprise network segment, such as a department or tenant that is logically segregated from others using separate VRs.

At 1310, the system determines the source virtual router from which the network traffic (e.g., one or more packets) was received. In some embodiments, the branch identifies the source virtual router instance from which the packet originated. This determination may be based on the ingress interface, VLAN tag, or internal routing table associations.

At 1315, the system determines the virtual router ID for the source virtual router. In some embodiments, the branch queries (e.g., consults, performs a lookup, etc.) an SD-WAN orchestration system to retrieve the globally unique identifier (VR ID) corresponding to the local VR. This VR ID has been previously provisioned by a central orchestrator to ensure consistency across the SD-WAN fabric.

At 1320, the system configures one or more packets to forward to a corresponding destination. In some embodiments, the system (e.g., the branch device) prepares the packet for SD-WAN transport. As an illustrative example, this preparation for SD-WAN transport includes encapsulating the packet with a tunnel header, such as a Geneve or VXLAN header. The tunnel header includes the VR ID in a designated field (e.g., Geneve VNI), which conveys the VR context of the packet to downstream nodes (e.g., the hub).

At 1325, the system sends the network traffic (e.g., the configured one or more packets) to the corresponding destination. In some embodiments, the system (e.g., the branch) transmits the encapsulated packet across the SD-WAN tunnel toward the destination hub node. The tunnel itself may be shared by multiple VRs, but the inclusion of the VR ID allows the receiving node to disambiguate the source context.

At 1330, the system receives the network traffic. In some embodiments, the hub receives the packet(s) (e.g., the packet(s) transmitted by the branch device).

At 1335, the system processes the network traffic. In some embodiments, the hub extracts the VR ID from the encapsulated tunnel header.

At 1340, the system stores an association between the packet and the zone and/or virtual context router. In some embodiments, the hub associates the packet with the correct zone and virtual router context. This enables correct application of routing, policy enforcement, and NAT in accordance with the client's VR.

At 1345, the system determines whether process 1300 is complete. In some embodiments, process 1300 is determined to be complete in response to a determination that no further network traffic is to be routed/handled, no further network traffic sessions are to be initiated, no further virtual router identifier is to be stored in association with a session identifier, an administrator indicates that process 1300 is to be paused or stopped, etc. In response to a determination that process 1300 is complete, process 1300 ends. In response to a determination that process 1300 is not complete, process 1300 returns to 1305.

According to various embodiments, the system (e.g., by implementing process 1300) enables multiple virtual routers at branch locations to share physical tunnel infrastructure while maintaining full routing and policy separation. This process supports use cases such as multi-tenant branch networks, overlapping IP addressing, and secure traffic steering to centralized gateways or firewalls.

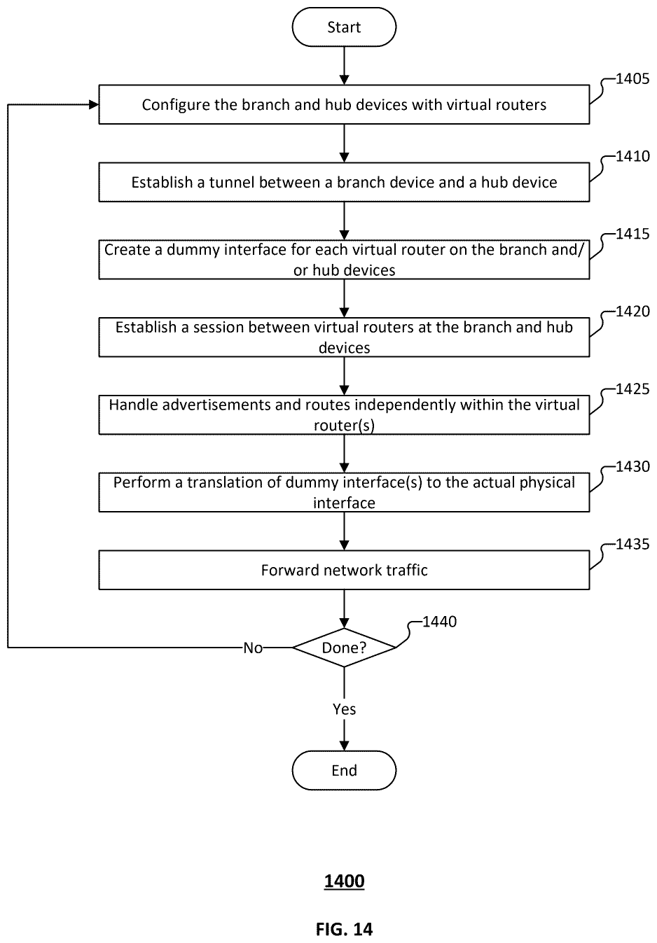

FIG. 14 is a flow diagram of a method for establishing independent BGP sessions for a virtual router(s) using dummy interfaces according to various embodiments. In some embodiments, process 1400 is implemented at least in part by system 100 of FIG. 1, system 200 of FIG. 2, system 300 of FIG. 3, system 300 of FIG. 3, and/or system 400 of FIG. 4.

According to various embodiments, the system implements routing (e.g., BGP routing) between virtual routers (VRs) at SD-WAN branch and hub locations using dummy SD-WAN interfaces. In this architecture, a single physical SD-WAN tunnel may carry traffic from multiple VRs. To enable routing protocol sessions (such as BGP) to operate independently for each VR, the system creates logical “dummy” interfaces inside each VR that reference the common physical tunnel interface. These dummy interfaces allow the control plane (e.g., routing daemon) to treat the tunnel as belonging to the VR, thereby enabling protocol peering and route learning. During route publishing, the system translates control plane entries referring to dummy interfaces to reference the underlying physical tunnel interface in the data plane.

Returning to the example shown, at 1405, the system configures the branch and hub devices with virtual routers (VRs). In some embodiments, the system configures the SD-WAN branch and hub devices with multiple virtual routers (VRs). Each VR is associated with a distinct logical routing instance and may have overlapping address spaces or independent routing policies.

At 1410, the system establishes a tunnel/communication channel between the branch device and the hub device. In some embodiments, a physical SD-WAN tunnel is established between the branch and hub devices. This tunnel is capable of carrying traffic associated with multiple VRs, but is not itself directly assigned to any one VR.

At 1415, the system creates a dummy interface for each virtual router on the branch and/or hub devices. In some embodiments, the system creates a dummy SD-WAN interface for each VR on both the branch and the hub. Each dummy interface is logically associated with the physical SD-WAN tunnel interface. From the perspective of the control plane (e.g., routing software within the VR), the dummy interface appears as a local tunnel interface.

At 1420, the system establishes a session between virtual routers at the branch and hub devices. In some embodiments, the routing control plane (e.g., BGP process) running within each VR establishes a BGP session with its peer VR (e.g., VR1 at branch peers with VR1 at hub). This is enabled by the presence of the dummy interface, which satisfies the routing daemon's requirement for a local interface through which the peer can be reached.

At 1425, the system handles advertisements and routes independently within the virtual routers. In some embodiments, the BGP advertisements and learned routes are handled independently within each VR. The routes learned via BGP are installed in the respective VR's routing table, and control plane entries record the dummy interface as the next hop interface.

At 1430, the system performs a translation of dummy interface(s) to the actual physical tunnel interface. In some embodiments, when routes are published to the data plane, the system replaces references to dummy interfaces with the actual physical tunnel interface that underlies the dummy interface. This translation ensures that forwarding paths in the data plane are valid and efficient, without requiring multiple physical tunnels for each VR.

At 1435, the system forwards network traffic, for example, based at least in part on the translation(s) between dummy interface(s) and the physical tunnel interface. In some embodiments, traffic forwarded according to these routes is encapsulated and transmitted over the physical SD-WAN tunnel. Because the system includes a VR ID in the tunnel header (as described above), the receiving node can perform a route lookup and session handling in the correct VR context.

At 1440, the system determines whether process 1400 is complete. In some embodiments, process 1400 is determined to be complete in response to a determination that no further network traffic is to be routed/handled, an administrator indicates that process 1400 is to be paused or stopped, etc. In response to a determination that process 1400 is complete, process 1400 ends. In response to a determination that process 1400 is not complete, process 1400 returns to 1405.

According to various embodiments, by implementing dummy SD-WAN interfaces for each VR, the system allows multiple routing protocol instances to run in parallel over shared tunnel infrastructure. This enables scalable, logically isolated BGP peering across many VRs without duplicating physical resources, while maintaining strict routing and policy segregation.

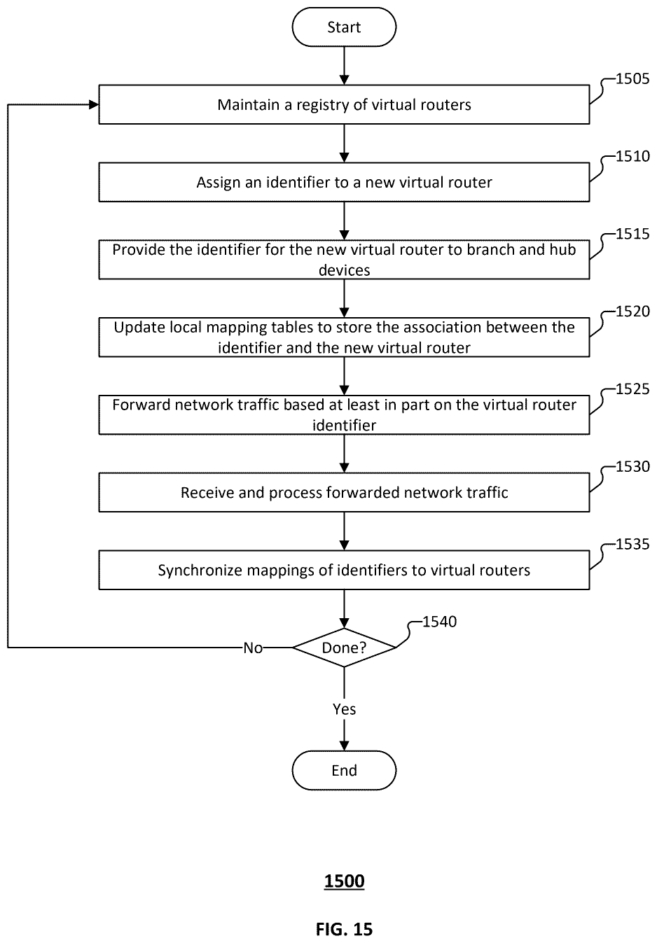

FIG. 15 is a flow diagram of a method for orchestrating virtual router identifier consistency across a plurality of hubs and branch devices. In some embodiments, process 1600 is implemented at least in part by system 100 of FIG. 1, system 200 of FIG. 2, system 300 of FIG. 3, system 300 of FIG. 3, and/or system 400 of FIG. 4.

According to various embodiments, the system comprises an a centralized orchestration system that assigns and distributes globally unique virtual router identifiers (VR IDs) across a distributed SD-WAN network comprising multiple hubs and branches. The orchestration ensures that each virtual router instance, even if it exists across different physical sites, is consistently identified by a shared VR ID. This allows for end-to-end routing, policy enforcement, and tunnel encapsulation across shared infrastructure (e.g., while enabling features such as overlapping IP address spaces and policy-isolated traffic handling per VR).

Returning to the example shown, at 1505, the system configures/maintains a registry of virtual routers. In some embodiments, the system (e.g., a central orchestration system) maintains a registry of virtual routers deployed across a plurality of SD-WAN hubs and branches. Each virtual router is assigned a global VR ID that uniquely identifies it across the entire SD-WAN domain.

At 1510, the system assigns an identifier to a new virtual router. In some embodiments, when a new virtual router instance is created at a branch or hub (e.g., VR1 at Branch A or VR1 at Branch B), the system (e.g., the central orchestration system) determines whether a global VR ID has already been assigned to the logical group (e.g., tenant or logical domain) it represents. If so, the system (e.g., the central orchestration system) reuses the existing global VR ID. If not, the system generates a new globally unique VR ID for that instance. The system can store the association between the VR ID and the new virtual router, for example, to the registry of virtual routers.

At 1515, the system provides the identifier for the new virtual router to branch and hub devices. In some embodiments, the system (e.g., the central orchestration system) communicates the assigned VR ID to the local control planes of the branch and hub devices. This may occur via configuration push (e.g., API, CLI, or configuration file deployment) or dynamically through a controller-agent protocol.

At 1520, the system updates local mapping tables based at least in part on the identifier for the new virtual router. For example, the system stores the association between the identifier and the new virtual router. In some embodiments, each SD-WAN device updates its VR-to-ID mapping table. This table maps locally instantiated VRs to their respective global VR IDs. This mapping is later used for tunnel encapsulation, policy determination, and session lookup.

At 1525, the system forwards network traffic based at least in part on the VR identifier. For example, the system encapsulates the VR ID in the network traffic being forwarded. In some embodiments, when traffic is forwarded from a branch device through the SD-WAN tunnel, the local device encapsulates the traffic with the appropriate VR ID in the tunnel header. For example, the VR ID may be encoded in the GENEVE VNI field or another tunnel metadata field.

At 1530, the system (e.g., a hub device) receives the forwarded network traffic. In some embodiments, when a hub device receives the encapsulated traffic, it extracts the VR ID from the header and uses the mapping table to resolve the corresponding VR context in which to process the packet. This allows the hub to enforce policies, route the packet appropriately, and assign a session zone that is derived from the VR rather than from the tunnel interface.

At 1535, the system synchronizes the mappings of identifiers to virtual routers. In some embodiments, the system (e.g., the central orchestration system) ensures consistency across the network by continuously (or periodically) synchronizing VR ID assignments and mappings across all devices participating in the SD-WAN fabric. This prevents VR ID collisions and enables seamless communication between VR instances even across disparate branches.

At 1540, the system determines whether process 1500 is complete. In some embodiments, process 1500 is determined to be complete in response to a determination that no further network traffic is to be routed/handled, an administrator indicates that process 1500 is to be paused or stopped, etc. In response to a determination that process 1500 is complete, process 1500 ends. In response to a determination that process 1500 is not complete, process 1500 returns to 1505.

According to various embodiments, through centralized management of globally unique VR IDs, the system ensures scalable and deterministic handling of traffic in SD-WAN environments with overlapping IP address spaces and per-tenant segmentation requirements. This coordination underpins the multi-VR constructs described in prior figures and enables consistent enforcement of routing and security policies across the distributed network.

Various examples of embodiments described herein are described in connection with flow diagrams. Although the examples may include certain steps performed in a particular order, according to various embodiments, various steps may be performed in various orders and/or various steps may be combined into a single step or in parallel.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A method for managing traffic in a Software-Defined Wide Area Network (SD-WAN) comprising a hub and multiple spoke, each spoke having one or more Virtual Routers (VRs), comprising:
receiving, at the hub, encapsulated traffic from a spoke over a tunnel, wherein the encapsulated traffic includes a global virtual router identifier (VR_ID) corresponding to a VR on the spoke;
determining, based on the global VR_ID, a zone associated with the VR; and
forwarding return traffic to the spoke by encapsulating the return traffic with the global VR_ID corresponding to the VR on the spoke.

2. The method of claim 1, further comprising assigning, via a central controller, unique global VR_IDs to each VR across the hub and the multiple spokes.

3. The method of claim 1, wherein the zone associated with each VR is configured by a user.

4. The method of claim 1, further comprising establishing, in each VR on the hub, a dummy SD-WAN interface that includes an original SD-WAN interface as a member, the original SD-WAN interface being associated with the tunnel.

5. The method of claim 4, further comprising establishing independent routing protocol peering for each VR over the tunnel using the respective dummy SD-WAN interface.

6. The method of claim 5, wherein the routing protocol is Border Gateway Protocol (BGP).

7. The method of claim 5, further comprising modifying routes learned via the routing protocol to point directly to an underlying tunnel virtual interface (VIF) when publishing the routes to a data plane.

8. The method of claim 7, wherein the underlying tunnel VIF is part of the original SD-WAN interface.

9. The method of claim 1, wherein the global VR_ID is included in an encapsulated header of the tunnel.

10. The method of claim 1, wherein one or more of the hub and a spoke enforce one or more security policies, and the security policies include firewall rules specific to a particular zone.

11. The method of claim 1, further comprising applying one or more security policies to the traffic based on the determined zone.

12. The method of claim 1, wherein forwarding the return traffic to the spoke comprises:
performing a lookup of virtual routing and forwarding (VRF) information stored in association with a particular session to obtain routing information; and
routing network traffic based at least in part on the routing information.

13. The method of claim 1, wherein the hub comprises a next generation firewall (NGFW).

14. The method of claim 1, wherein each spoke comprises a firewall.

15. The method of claim 1, further comprising storing an ingress virtual routing and forwarding (VRF) information in connection with a client-server flow information for a particular session, comprising:
receiving an client-to-server flow of network traffic;
determining a source virtual route forwarder from which the client-to-server flow is received; and
storing source VRF information in connection with the particular session.

16. The method of claim 1, further comprising storing an ingress virtual routing and forwarding (VRF) information in connection with a client-server flow information for a particular session, comprising:
in response to receiving a client-to-server flow, storing session information for the client-to-server flow, wherein the session information comprises a tuple that uniquely identifies a session associated with the client-to-server flow.

17. The method of claim 16, wherein the tuple comprises a source address, a destination address, a source port, a destination port, a protocol, and a security zone.

18. The method of claim 1, wherein forwarding the return traffic comprises:
bypassing a route look up with respect to an internet virtual route forwarder (VRF) and performing a route look up with respect to ingress VRF information obtained from a session lookup.

19. A system for managing traffic in a Software-Defined Wide Area Network (SD-WAN) comprising a hub and multiple spoke, each spoke having one or more Virtual Routers (VRs), comprising:
one or more processors configured to:
receive, at the hub, encapsulated traffic from a spoke over a tunnel, wherein the encapsulated traffic includes a global virtual router identifier (VR_ID) corresponding to a VR on the spoke;
determine, based on the global VR_ID, a zone associated with the VR; and
forward return traffic to the spoke by encapsulating the return traffic with the global VR_ID corresponding to the VR on the spoke; and
a memory coupled to the one or more processors and configured to provide the one or more processors with instructions.

20. A computer program product for managing traffic in a Software-Defined Wide Area Network (SD-WAN) comprising a hub and multiple spoke, each spoke having one or more Virtual Routers (VRs), the computer program product being embodied in a non-transitory computer readable medium and comprising computer instructions for:
receiving, at the hub, encapsulated traffic from a spoke over a tunnel, wherein the encapsulated traffic includes a global virtual router identifier (VR_ID) corresponding to a VR on the spoke;
determining, based on the global VR_ID, a zone associated with the VR; and
forwarding return traffic to the spoke by encapsulating the return traffic with the global VR_ID corresponding to the VR on the spoke.
